(19) United States
(12) Patent Application Publication
(10) Pub. No.: US 2026/0025180 A1
(43) Pub. Date: Jan. 22, 2026

(54) MEASUREMENT CONFIGURATIONS FOR WIRELESS DEVICE (WD)-SIDED TIME DOMAIN BEAM PREDICTIONS

(71) Applicant: Telefonaktiebolaget LM Ericsson (publ), Stockholm (SE)

(72) Inventors: Jingya LI, Göteborg (SE); Andreas NILSSON, Göteborg (SE); Icaro Leonardo DA SILVA, Solna (SE); Chunhui LI, Kanagawa (JP); Henrik RYDÉN, Stockholm (SE)

(21) Appl. No.: 18/997,997

(22) PCT Filed: Aug. 3, 2023
(86) PCT No.: PCT/SE2023/050775

§ 371 Date: Jan. 23, 2025

Related U.S. Application Data
(60) Provisional application No. 63/395,496, filed on Aug. 5, 2022.
(60) Provisional application No. 63/395,674, filed on Aug. 5, 2022.

(51) Int. Cl. H04B 7/06; H04W 72/0446

(52) U.S. Cl. CPC H04B 7/0626; H04B 7/06952; H04W 72/0446

(57) ABSTRACT

A method, network node and wireless device (WD) for providing measurement configurations for WD-sided time domain beam predictions are disclosed. According to one aspect, a method in a WD includes receiving from the network node a CSI report configuration configuring the WD to report at least one prediction of CSI based at least in pant on a downlink reference signal configuration. The method also includes transmitting to the network node abeam information report including at least one prediction of CSI for at least one future time instance of a first set of at least one future time instance in accordance with the CSI report configuration.

### TECHNICAL FIELD

The present disclosure relates to wireless communications, and in particular, to measurement configurations for wireless device (WD)-sided time domain beam predictions.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Beam Management

### Beam Management Procedure

In high frequency range (FR2), multiple radio frequency (RF) beams may be used to transmit and receive signals at a network node (gNB) and a WD. For each downlink (DL) beam from a network node, there is typically an associated best WD receive (Rx) beam for receiving signals from the DL beam. The DL beam and the associated WD Rx beam form a beam pair. The beam pair may be identified through a so-called beam management process in NR.

A DL beam is (typically) identified by an associated DL reference signal (RS) transmitted in the beam, either periodically, semi-persistently, or aperiodically. The DL RS for the purpose may be a Synchronization Signal (SS) and Physical Broadcast Channel (PBCH) block (SSB) or a Channel State Information RS (CSI-RS). By measuring all the DL RSs, the WD may determine and report to the network node the best DL beam to use for DL transmissions. The network node may then transmit a burst of DL-RS in the reported best DL beam to let the WD evaluate candidate WD Rx beams.

Although not explicitly stated in the NR specification, beam management has been divided into three example procedures, schematically illustrated in FIG. 1:
P-1: Purpose is to find a coarse direction for the WD using wide network node TX beam covering the whole angular sector;
P-2: Purpose is to refine the network node TX beam by doing a new beam search around the coarse direction found in P1; and
P-3: Used for WD that has analog beamforming to let them find a suitable WD Rx beam.

P-1 is expected to utilize beams with rather large beamwidths, where the beam reference signals are transmitted periodically and are shared between all WDs of the cell. Typically, reference signal to use for P-1 are periodic CSI-RS or SSB. The WD then reports the N best beams to the network node and their corresponding reference signal received power (RSRP) values.

P-2 is expected to use aperiodic/or semi-persistent CSI-RS transmitted in narrow beams around the coarse direction found in P-1.

P-3 is expected to use aperiodic or semi-persistent CSI-RSs repeatedly transmitted in one narrow network node beam. One alternative way is to let the WD determine a suitable WD Rx beam based on the periodic SSB transmission. Since each SSB has four orthogonal frequency division multiplexed (OFDM) symbols, a maximum of four WD Rx beams may be evaluated during each SSB burst transmission. One benefit with using SSB instead of CSI-RS is that no extra overhead of CSI-RS transmission is needed.

### Beam Indication

In NR, several signals may be transmitted from different antenna ports of a same base station. These signals may have the same large-scale properties such as Doppler shift/spread, average delay spread, or average delay. These antenna ports are then said to be quasi co-located (QCL).

If the WD knows that two antenna ports are QCL with respect to a certain parameter (e.g., Doppler spread), the WD may estimate that parameter based on one of the antenna ports and apply that estimate for receiving signals on the other antenna port.

For example, there may be a QCL relation between a CSI-RS for tracking RS (TRS) and the physical downlink shared channel (PDSCH) demodulation reference signal (DMRS). When the WD receives the PDSCH DMRS, the WD may use the measurements already made on the TRS to assist the DMRS reception.

Information about what assumptions may be made regarding QCL is signaled to the WD from the network. In NR, four types of QCL relations between a transmitted source RS and transmitted target RS have been defined:
Type A: {Doppler shift, Doppler spread, average delay, delay spread};
Type B: {Doppler shift, Doppler spread};
Type C: {average delay, Doppler shift}; and
Type D: {Spatial Rx parameter}.

QCL type D was introduced in NR to facilitate beam management with analog beamforming and is known as spatial QCL. There is currently no strict definition of spatial QCL, but the understanding is that if two transmitting antenna ports are spatially QCL, the WD may use the same Rx beam to receive signals. This is helpful for a WD that uses analog beamforming to receive signals, since the WD needs to adjust its Rx beam in some direction prior to receiving a certain signal. If the WD knows that the signal is spatially QCL with some other signal it has received earlier, then it may safely use the same Rx beam to receive this signal.

In NR, the spatial QCL relation for a DL or UL signal/channel may be indicated to the WD by using a “beam indication”. The “beam indication” is used to help the WD to find a suitable Rx beam for DL reception, and/or a suitable TX beam for UL transmission. In NR, the “beam indication” for DL is conveyed to the WD by indicating a transmission configuration indicator (TCI) state to the WD, while in UL the “beam indication” may be conveyed by indicating a DL-RS or UL-RS as spatial relation (in NR 3GPP Technical Releases 15 and 16, (3GPP Rel-15/16)) or a TCI state (in 3GPP Rel-17).

Beam Management with Unified TCI Framework

In NR, downlink beam management is performed by conveying spatial QCL (‘Type D’) assumptions to the WD through TCI states.

In 3GPP Rel-15 and Rel-16, for the physical downlink control channel (PDCCH), the network (NW), e.g., the network node, configures the WD with a set of PDCCH TCI states by radio resource control (RRC) signaling, and then activates one TCI state per control resource set (CORESET) using a medium access control (MAC) control element (CE). For PDSCH beam management, the network node configures the WD with a set of PDSCH TCI states by RRC, and then activates up to 8 TCI states by MAC CE. After activation, the NW dynamically indicates one of these activated TCI states using a TCI field in downlink control information (DCI) when scheduling PDSCH.

Such a framework allows great flexibility for the network to instruct the WD to receive signals from different spatial directions in the DL with a cost of large signaling overhead and slow beam switch. These limitations are particularly noticeable and costly when WD movement is considered. One example is that a beam update using DCI may only be performed for PDSCH, and MAC-CE and/or RRC is required to update the beam for other reference signals or channels. This causes extra overhead and latency.

Furthermore, in a majority of cases, the network transmits to and receives from a WD in the same direction for both data and control. Hence, using a separate framework (TCI state respective spatial relations) for different channels/signals complicates the implementations.

In 3GPP Rel-17, a common beam framework was introduced to simplify beam management in frequency range FR2, in which a common beam represented by a TCI state may be activated or indicated to a WD and the common beam is applicable for multiple channels/signals such as PDCCH and PDSCH. The common beam framework is also referred to as a unified TCI state framework.

The new framework may be RRC configured in one of two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state may be updated in a similar way as the TCI state update for PDSCH in 3GPP Rel-15/16, i.e., with one of two alternatives:
Two-stage: RRC signaling is used to configure a number of unified TCI states in higher layer parameter PDSCH-config, and a MAC-CE is used to activate one of unified TCI states; or
Three-stage: RRC signaling is used to configure a number of unified TCI states in PDSCH-config, a MAC-CE is used to activate up to 8 unified TCI states, and a 3-bit TCI state bitfield in DCI is used to indicate one of the activated unified TCI states.

The one activated or indicated unified TCI state will be used in subsequent PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, acknowledgement/non-acknowledgement (ACK/NACK) of the PDSCH may be used as an indication of successful reception of beam indication. For DCI formats 1_1 and 1_2 without DL assignment, a new ACK/NACK mechanism analogous to that for semi-persistently scheduled (SPS) PDSCH release with both type-1 and type-2 hybrid automatic repeat request (HARQ)-acknowledgment (ACK) codebook is used, where upon a successful reception of the beam indication DCI, the WD reports an ACK.

For DCI-based beam indication, the first slot to apply the indicated TCI is at least Y symbols after the last symbol of the acknowledgment of the joint or separate DL/UL beam indication. The Y symbols are configured by the network node based on WD capability, which is also reported in units of symbols. The values of Y have not yet been determined and is left to RAN4 to consider.

### Reference Signal

### Reference Signal Configurations

### CSI-RS:

A CSI-RS is transmitted over each transmit (Tx) antenna port at the network node and for different antenna ports. The CSI-RS are multiplexed in the time, frequency, and code domains such that the channel between each Tx antenna port at the network node and each receive antenna port at a WD may be measured by the WD. The time-frequency resource used for transmitting CSI-RS is referred to as a CSI-RS resource.

In NR, the CSI-RS for beam management is defined as a 1- or 2-port CSI-RS resource in a CSI-RS resource set where the filed repetition is present. The following three types of CSI-RS transmissions are supported:
Periodic CSI-RS: CSI-RS is transmitted periodically in certain slots.

This CSI-RS transmission is semi-statically configured using RRC signaling with parameters such as CSI-RS resource, periodicity, and slot offset;
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission; and
Aperiodic CSI-RS: This is a one-shot CSI-RS transmission that may happen in any slot. Here, one-shot means that CSI-RS transmission only happens once per trigger. The CSI-RS resources (i.e., the resource element (RE) locations which has subcarrier locations and orthogonal frequency division multiplexed (OFDM) symbol locations) for aperiodic CSI-RS are semi-statically configured. The transmission of aperiodic CSI-RS is triggered by dynamic signaling through PDCCH using the CSI request field in UL DCI, in the same DCI where the UL resources for the measurement report are scheduled. Multiple aperiodic CSI-RS resources may be included in a CSI-RS resource set and the triggering of aperiodic CSI-RS is on a resource set basis.

### SSB:

In NR, a synchronization signal block (SSB) has a pair of synchronization signals (SSs), physical broadcast channel (PBCH), and DMRS for PBCH. An SSB is mapped to 4 consecutive OFDM symbols in the time domain and 240 contiguous subcarriers (20 RBs) in the frequency domain.

To support beamforming and beam-sweeping for SSB transmission, in NR, a cell may transmit multiple SSBs in different narrow-beams in a time multiplexed fashion. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame are broadcasted periodically from each cell. The periodicity of the half frames with SS/PBCH blocks is referred to as SSB periodicity, which is indicated by system information block (SIB1).

The maximum number of SSBs within a half frame, denoted by L, depends on the frequency band, and the time locations for these L candidate SSBs within a half frame depends on the subcarrier spacing (SCS) of the SSBs. The L candidate SSBs within a half frame are indexed in an ascending order in time from 0 to L−1. By successfully detecting PBCH and its associated DMRS, a WD knows the SSB index. A cell does not necessarily transmit SS/PBCH blocks in all L candidate locations in a half frame, and the resource of the unused candidate positions may be used for the transmission of data or control signaling instead. It is up to network implementation to decide which candidate time locations to select for SSB transmission within a half frame, and which beam to use for each SSB transmission.

### Measurement Resource Configurations

In NR, a WD may be configured with N≥1 CSI reporting settings (i.e., CSI-ReportConfig), M≥1 resource settings (i.e., CSI-ResourceConfig), where each CSI reporting setting is linked to one or more resource settings for channel and/or interference measurements. The CSI framework is modular, meaning that several CSI reporting settings may be associated with the same Resource Setting.

The measurement resource configurations for beam management may be provided to the WD by RRC IEs CSI-ResourceConfigs. One CSI-ResourceConfig contains several NZP-CSI-RS-ResourceSets and/or CSI-SSB-ResourceSets.

A WD may be configured to perform measurement on CSI-RSs. Here the RRC information element (IE) NZP-CSI-RS-ResourceSet is used. A non-zero power (NZP) CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources may be grouped to a NZP-CSI-RS-ResourceSet. A WD may also be configured to perform measurements on SSBs. Here, the RRC IE CSI-SSB-ResourceSet is used. Resource sets including SSB resources are defined in a similar manner.

In the case of aperiodic CSI-RS and/or aperiodic CSI reporting, the network node configures the WD with Sc CSI triggering states. Each triggering state contains the aperiodic CSI report setting to be triggered along with the associated aperiodic CSI-RS resource sets.

Periodic and semi-persistent Resource Settings may only include a single resource set (i.e., S=1) while S>=1 for aperiodic Resource Settings. This is because in the aperiodic case, one out of the S resource sets included in the Resource Setting is indicated by the aperiodic triggering state that triggers a CSI report.

### Measurement Reporting

Three types of CSI reporting are supported in NR as follows:
Periodic CSI Reporting on PUCCH: CSI is reported periodically by a WD. Parameters such as periodicity and slot offset are configured semi-statically by higher layer RRC signaling from the network node to the WD;
Semi-Persistent CSI Reporting on PUSCH or PUCCH: similar to periodic CSI reporting, semi-persistent CSI reporting has a periodicity and slot offset which may be semi-statically configured. However, a dynamic trigger from network node to WD may be needed to allow the WD to begin semi-persistent CSI reporting. A dynamic trigger from network node to WD is needed to request the WD to stop the semi-persistent CSI reporting; and
Aperiodic CSI Reporting on PUSCH: This type of CSI reporting involves a single-shot (i.e., one time) CSI report by a WD which is dynamically triggered by the network node using DCI. Some of the parameters related to the configuration of the aperiodic CSI report is semi-statically configured by RRC but the triggering is dynamic.

In each CSI reporting setting, the content and time-domain behavior of the report is defined, along with the linkage to the associated Resource Settings. The CSI-ReportConfig IE include the following configurations:
reportConfigType
   Defines the time-domain behavior, i.e., periodic CSI reporting, semi-persistent CSI reporting, or aperiodic CSI reporting, along with the periodicity and slot offset of the report for periodic CSI reporting;
reportQuantity
   Defines the reported CSI parameter(s) (i.e., the CSI content), such as precoder matrix indicator (PMI), channel quality index (CQI), rank indicator (RI), layer indicator (LI)), CSI-RS resource index (CRI) and L1-reference signal received power (RSRP). Only a certain number of combinations are possible (e.g., ‘cri-RI-PMI-CQI’ is one possible value and ‘cri-RSRP’ is another) and each value of reportQuantity may correspond to a certain CSI mode;
codebookConfig
   Defines the codebook used for PMI reporting, along with possible codebook subset restriction (CBSR). Two “Types” of PMI codebook are defined in NR, Type I CSI and Type II CSI, each codebook type further has two variants each;
reportFrequencyConfiguration
   Define the frequency granularity of PMI and CQI (wideband or subband), if reported, along with the CSI reporting band, which is a subset of subbands of the bandwidth part (BWP) to which the CSI corresponds;
Measurement restriction in time domain (ON/OFF) for channel and interference respectively.

For beam management, a WD may be configured to report L1-RSRP for up to four different CSI-RS/SSB resource indicators. The reported RSRP value corresponding to the first (best) CRI/SS/PBCH Block Resource Indicator (SSBRI) requires 7 bits, using absolute values, while the others require 4 bits using encoding relative to the first. In NR 3GPP Rel-16, the report of L1-signal to interference plus noise ratio (SINR) for beam management has already been supported

### Beam Prediction

One example artificial intelligence/machine learning (AI/ML) model currently discussed in the AI for air-interface 3GPP Rel-18 includes predicting the channel with respect to a beam for a certain time-frequency resource. The expected performance of such predictor depends on several different aspects, including time/frequency variation of channel due to WD mobility or changes in the environment. Due to the inherit correlation in time, frequency and the spatial domain of the channel, a machine learning (ML) model may be trained to exploit such correlations. The spatial domain may include different beams, where the correlation properties partly depend on the how the network node antennas forms the different beams, and how WD forms the receiver beams.

The device may use such prediction ML-model to reduce measurement requirements related to beamforming. In NR, a device may be requested to measure on a set of SSB beams or/and CSI-RS beams. A stationary device typically experiences less variations in beam quality in comparison to a moving device. The stationary device may therefore save battery power and reduce the number of beam measurements by instead using an ML model to predict the beam quality without an explicit measurement. It may do this, for example, by measuring a subset of the beams and predicting the rest of the beams. As shown in a 3GPP technical document, one can, with the use of AI, measure on a subset of beams in order to predict the best beam, which may reduce up to 75% measurement time.

A known method enables a WD to predict future beam values based on historical values. Based on received device data from measurement reports, the network may learn, for example, which sequences of signal quality measurements (e.g., RSRP measurements) lead to large signal quality drop events (e.g., turning around the corners as shown in FIG. 2). This learning procedure may be enabled, for example, by dividing periodically reported RSRP data into a training and prediction window.

In the example shown in FIG. 2, two devices move and turn around the same corner. Device 120b, marked by a dashed line, is the first to turn the corner and experience a large signal quality drop. A goal of using AI is to mitigate the drop of a second device (120a) by using learning from the first device's experiences.

The learning may be done by feeding RSRP in t₁, . . . , tₙ into a machine learning model (e.g., neural network), and then learning the RSRP in tₙ₊₁, tₙ₊₂. After the model is trained, the network may then predict future signal quality values, the signal quality prediction may then be used to avoid radio-link failure, or beam failure, by:
Initiate inter-frequency handover;
Set handover/reselection parameters;
Pre-emptively perform candidate beam selection to avoid beam failure; and/or
Change device scheduler priority, for example schedule device when the expected signal quality is good;

During the 3GPP meeting RAN1 #109-e a study of AI/ML based temporal beam prediction for a set A of beams based on measurement results of Set B of beams was considered, where the Set A of beams and Set B of beams may be the same set of beams or different set of beams. It was also considered that the measurement results of K (K>=1) latest measurement instances during a time window T1 of the Set B beams are used for AI/ML model input. Furthermore, it was considered that one or more beams from the Set A beams will be used as AI/ML model output, where the AI/ML model output should be F predictions for F future time instances, where all F future time instances are located within a time window T2.

It has been considered by the 3GPP that K measurement instances of Set B beams during a time window T1 will be used as input for the beam prediction AI/ML model. However, how the WD performs the set of K measurements for a Set B of beams within a time window T1 in the 3GPP specification is an open issue that needs to be solved. There is no existing solution to the problem, as currently, the CSI measurements which may be configured are for CSI reporting. In addition, it is not clear whether the WD and the network would be consistent in terms of what RSs are transmitted by the network and/or when and how the WD is meant to measure these RSs. Therefore, CSI measurements are used as input for the time-domain predictions, which may lead to inconsistencies between the WD and network.

### SUMMARY

Some embodiments advantageously provide methods, network nodes and wireless devices for providing measurement configurations for wireless device (WD)-sided time domain beam predictions.

Methods at a wireless device (WD) for performing time-domain predictions of measurements are disclosed. An example method may include one or more of the following steps:
Receiving from a network a message including a Channel State Information (CSI) measurement configuration (or CSI measurement prediction configuration) including a Downlink (DL) Reference Signal (RS) configuration;
Performing at least one CSI measurement on a first set of DL RSs (Set B), based on the DL RS configuration;
Performing one or more time-domain predictions of one of more CSI measurements on a second set of one or more DL RS(s) (Set A) based on the at least one measurement; and
Transmitting to the network node prediction information based on the one or more time-domain predictions of the one of more CSI measurements on one or more DL RS(s).

In some embodiments, the WD is configured with DL RSs (of one or more cells) transmitted by the network (Set B). The WD performs measurements (e.g., CSI measurements, such as L1 RSRP, SS-RSRP) on at least one of these configured DL RS (Set B) and, based on the performed measurements, the WD performs one or more time-domain predictions on DL RSs (Set A, which may be the same or different than Set B), to derive information to be reported to the network. The information to be reported may be the time-domain predictions on DL RSs of set A, or other information derived from the time-domain predictions on DL RSs of set A.

In some embodiments, the DL RSs which are configured for measurements (Set B) may be transmitted by the network in different spatial directions and/or with different spatial domain filters. Thus, these DL RSs correspond to a set of beams B, or Set B of beams, or set B.

In that sense, CSI measurements may be considered as beam measurements, or CSI measurements which are reported to the network for assisting beam management operations at the network side, such as the decision which further CSI/beam measurements to activate and/or which DL beams to be used for transmission of Downlink channels (e.g., CORESET(s), PDCCH instances, etc.), which Transmission Configuration Indication (TCI) state and associated QCL source to activate, etc.

In some embodiments, the second set of one or more DL RS(s) (Set A), i.e., the DL RSs for which the WD performs the one or more time-domain predictions of one of more CSI measurements, may also be transmitted by the network in different spatial directions and/or with different spatial domain filters. The DL RSs being predicted correspond to a set of beams A, or Set A of beams, or set A. Thus, the WD predicts future network node beams.

The disclosure also describes different methods at a network function (or network node), such as a gNodeB (e.g., a gNodeB Central Unit (CU) and/or a gNodeB Distributed Unit, baseband, radio unit, etc.), for configuring the WD to perform time-domain predictions of measurements. Some embodiments may include one or more of the following:
Transmitting to a WD a message including a CSI measurement configuration (or CSI measurement prediction configuration) including a DL Reference Signal (RS) configuration;
Transmitting a first set of DL RSs (Set B), according to DL RS configuration; and
Receiving from the WD prediction information based on the one or more time-domain predictions of the one or more CSI measurements on one or more DL RS(s).

At a network node, the method also includes performing one or more actions in response to receiving from the WD prediction information, such as i) the activation and/or deactivation or one or more TCI states (by transmission of a MAC CE and/or a DCI to the WD); ii) the activation and/or deactivation or one or more beams; ii) the activation and/or deactivation of one or more CSI measurements in one or more beams; iii) the re-configuration (e.g., addition, release, modification, etc.) of one or more TCI states (by transmission of an RRC Reconfiguration message to the WD); iv) the re-configuration (e.g., addition, release, modification, etc.) of one or more beams; v) the re-configuration (e.g., addition, release, modification, etc.) of one or more CSI measurements in one or more beams.

The WD is configured with DL RSs on which the WD performs one or more measurements (e.g., CSI measurements, such as L1 RSRP). Based on these measurements, the WD is able to perform one or more time-domain predictions, which may be used for reporting predicted information to the network.

In some embodiments, a method enables beam prediction at the WD for 5G and/or 6G, which reduces DL-RS overhead, since the WD may send predictions (instead of measurements) for the time occasions in which the DL RSs would not need to be transmitted. This may result in fewer DL-RSs transmissions. In addition, WD measurement complexity during beam management procedures may be reduced since the WD would perform fewer measurements (e.g., no measurements for the same beam in occasions in which predictions have been performed). Performing fewer measurements may also reduce WD energy consumption, since instead of performing measurements in certain time occasions in the future, the WD may perform predictions.

According to one aspect, a wireless device, WD, configured to perform time domain predictions of network node beams from a set A of beams based on measurements of a set B of beams is provided. The WD is configured to receive from a network node a CSI report configuration configuring the WD to report at least one prediction of a beam from Set A of beams based on a downlink reference signal configuration associated with the set B of beams. The WD is also configured to transmit to the network node a beam information report including at least one prediction of a beam from Set A of beams for at least one future time instance of a first set of at least one future time instance in accordance with the CSI report configuration.

According to this aspect, in some embodiments, the CSI report configuration further includes an indication of the at least one future time instance for the at least one beam prediction. In some embodiments, the at least one future time instance includes a plurality of future time instances that are equally distributed in time. In some embodiments, a first subset of the first set of future time instances is separated from a second subset of the first set of future time instances by a gap. In some embodiments, the beam information report includes an instantaneous beam report. In some embodiments, the CSI report configuration includes a beam prediction configuration indicating at least one beam for performing the at least one beam prediction. In some embodiments, the beam prediction configuration indicates a prediction window for which beam predictions are determined. In some embodiments, the beam prediction configuration indicates a plurality of prediction times for which beam predictions are determined. In some embodiments, the beam prediction configuration indicates a first set of prediction times for a first set of beam predictions in a first window and a second set of prediction times for a second set of beam predictions in a second window. In some embodiments, the WD is configured to transmit a beam prediction capability including at least one of prediction window parameters, measurement window parameters and a delay between a measurement window and a prediction window.

According to another aspect, a method in a wireless device, WD, configured to communicate with a network node and configured to perform time domain predictions of and configured to perform time domain predictions of network node beams from a set A of beams based on measurements of a set B of beam channel state information, CSI, measurements is provided. The method includes receiving from the network node a CSI report configuration configuring the WD to report at least one prediction of a beam from set A of beams based on a downlink reference signal configuration associated with the set B of beams. The method also includes transmitting to the network node a beam information report including at least one prediction of a beam from set A of beams for at least one future time instance of a first set of at least one future time instance in accordance with the CSI report configuration.

According to this aspect, in some embodiments, the CSI report configuration further includes an indication of the at least one future time instance for the at least one beam prediction. In some embodiments, the at least one future time instance includes a plurality of future time instances that are equally distributed in time. In some embodiments, a first subset of the first set of future time instances is separated from a second subset of the first set of future time instances by a gap. In some embodiments, the beam information report includes an instantaneous beam report. In some embodiments, the CSI report configuration includes a beam prediction configuration indicating at least one beam for performing the at least one beam prediction. In some embodiments, the beam prediction configuration indicates a prediction window for which beam predictions are determined. In some embodiments, the beam prediction configuration indicates a plurality of prediction times for which beam predictions are determined. In some embodiments, the beam prediction configuration indicates a first set of prediction times for a first set of beam predictions in a first window and a second set of prediction times for a second set of beam predictions in a second window. In some embodiments, the method includes transmitting a beam prediction capability including at least one of prediction window parameters, measurement window parameters and a delay between a measurement window and a prediction window.

According to yet another aspect, a network node configured to configure a wireless device, WD, to perform time domain predictions of network node beams from a set A of beams based on measurements of a set B of beams, is provided. The network node is configured to transmit to a WD a CSI report configuration configuring the WD to report at least one prediction of a beam from set A of beams based on a downlink reference signal configuration. The network node is also configured to receive from the WD a beam information report including at least one prediction of a beam from set A of beams for at least one future time instance of a first set of at least one future time instance in accordance with the CSI report configuration.

According to this aspect, in some embodiments, the CSI report configuration further includes an indication of the at least one future time instance for the at least one beam prediction. In some embodiments, the at least one future time instance includes a plurality of future time instances that are equally distributed in time. In some embodiments, a first subset of the first set of future time instances is separated from a second subset of the first set of future time instances by a gap. In some embodiments, the beam information report includes an instantaneous beam report. In some embodiments, the CSI report configuration includes a beam prediction configuration indicating at least one beam for performing the at least one beam prediction. In some embodiments, the beam prediction configuration indicates a prediction window for which beam predictions are determined. In some embodiments, the beam prediction configuration indicates a plurality of prediction times for which beam predictions are determined. In some embodiments, the beam prediction configuration indicates a first set of prediction times for a first set of beam predictions in a first window and a second set of prediction times for a second set of beam predictions in a second window. In some embodiments, the network node is configured to receive from the WD a beam prediction capability including at least one of prediction window parameters, measurement window parameters and a delay between a measurement window and a prediction window.

According to another aspect, a method in a network node configured to configure a wireless device, WD, to perform time domain predictions of network node beams from a set A of beams based on measurements of a set B of beams, is provided. The method includes transmitting to a WD a CSI report configuration configuring the WD to report at least one prediction of a beam from set A of beams based on a downlink reference signal configuration associated with the set B of beams. The method includes receiving from the WD a beam information report including at least one prediction of a beam from set A of beams for at least one future time instance of a first set of at least one future time instance in accordance with the CSI report configuration.

According to this aspect, in some embodiments, the CSI report configuration further includes an indication of the at least one future time instance for the at least one beam prediction. In some embodiments, the at least one future time instance includes a plurality of future time instances that are equally distributed in time. In some embodiments, a first subset of the first set of future time instances is separated from a second subset of the first set of future time instances by a gap. In some embodiments, the beam information report includes an instantaneous beam report. In some embodiments, the CSI report configuration includes a beam prediction configuration indicating at least one beam for performing the at least one beam prediction. In some embodiments, the beam prediction configuration indicates a prediction window for which beam predictions are determined. In some embodiments, the beam prediction configuration indicates a plurality of prediction times for which beam predictions are determined. In some embodiments, the beam prediction configuration indicates a first set of prediction times for a first set of beam predictions in a first window and a second set of prediction times for a second set of beam predictions in a second window. In some embodiments, the method includes receiving from the WD a beam prediction capability including at least one of prediction window parameters, measurement window parameters and a delay between a measurement window and a prediction window.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates three procedures involving different beam patterns;

FIG. 2 illustrates movement of two different wireless devices (WDs)′

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for providing measurement configurations for wireless device (WD)-sided time domain beam predictions according to principles disclosed herein;

FIG. 10 is a flowchart of an example process in a wireless device for WD-sided time domain beam predictions according to principles disclosed herein;

FIG. 11 is a flowchart of another example process in a network node for providing measurement configurations for WD-sided time domain beam predictions;

FIG. 12 is a flowchart of another example process in a wireless device for WD-sided time domain beam predictions according to principles disclosed herein;

FIG. 13 illustrates beam patterns for which predictions are made according to principles set forth herein;

FIG. 14 is a flowchart of another example process in a WD according to principles set forth herein;

FIG. 15 is a first example timing diagram according to principles disclosed herein;

FIG. 16 is a second example timing diagram according to principles disclosed herein;

FIG. 17 is a third example timing diagram according to principles disclosed herein;

FIG. 18 is an example process for beam prediction according to principles disclosed herein; and

FIG. 19 is a first timing diagram for CSI reporting occasions;

FIG. 20 is a second timing diagram for CSI reporting occasions;

FIG. 21 is a general example for timing measurement occasions and prediction occasions at future time instances; and

FIG. 22 illustrates a timing window for prediction occasions.

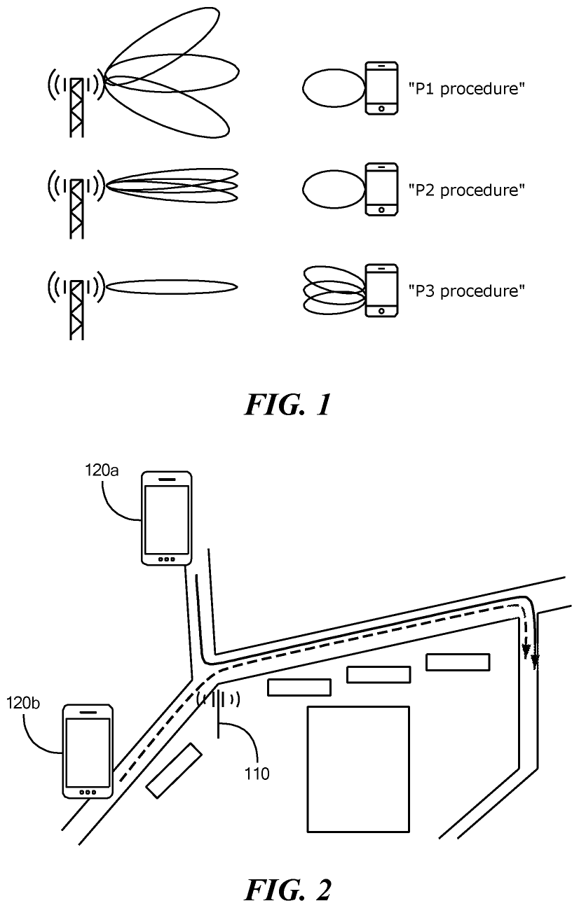

### DETAILED DESCRIPTION

Before describing in detail example embodiments, it is noted that the embodiments reside primarily in combinations of apparatus components and processing steps related to measurement configurations for wireless device (WD)-sided time domain beam predictions. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node included in a radio network which may further include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} pry node, a node external to the current network), nodes in distributed antenna system (DAS), a spectrum access system (SAS) node, an element management system (EMS), etc. The network node may also include test equipment. The term “radio node” used herein may be used to also denote a wireless device (WD).

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may include any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide measurement configurations for wireless device (WD)-sided time domain beam predictions.

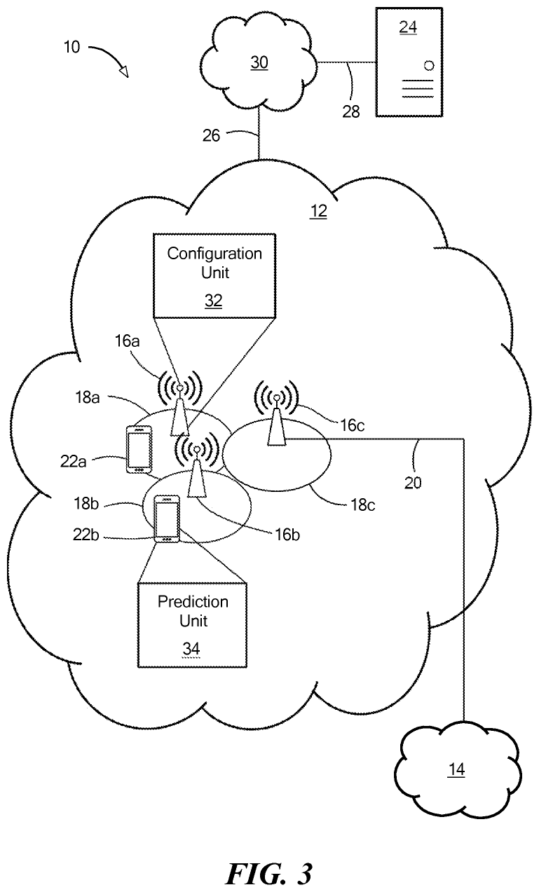

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which includes an access network 12, such as a radio access network, and a core network 14. The access network 12 includes a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may include two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure the WD with a downlink reference signal configuration and a channel state information, CSI, measurement configuration. A wireless device 22 is configured to include a prediction unit 34 which is configured to perform at least one temporal beam prediction based at least in part on the at least one measurement.

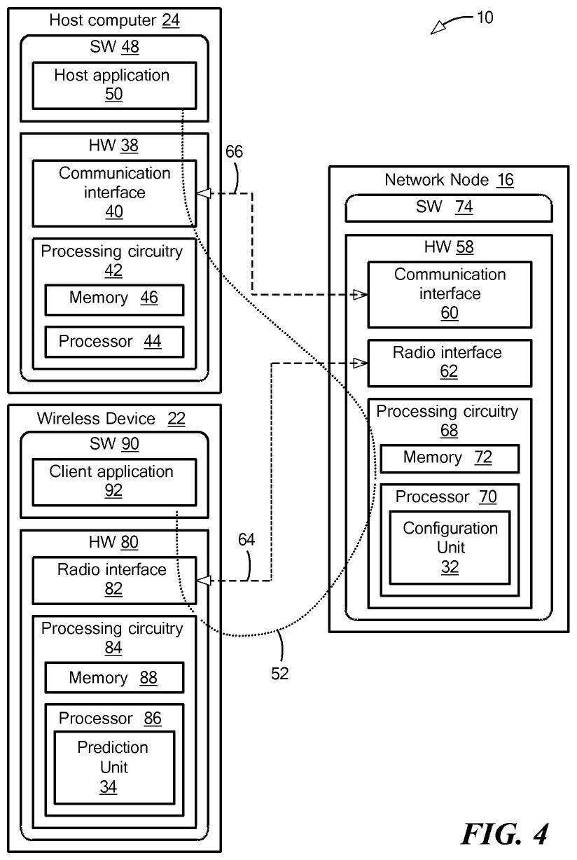

Example implementations, in accordance with an embodiment, of the WD 22, network node 16 and host computer 24 discussed in the preceding paragraphs will now be described with reference to FIG. 4. In a communication system 10, a host computer 24 includes hardware (HW) 38 including a communication interface 40 configured to set up and maintain a wired or wireless connection with an interface of a different communication device of the communication system 10. The host computer 24 further includes processing circuitry 42, which may have storage and/or processing capabilities. The processing circuitry 42 may include a processor 44 and memory 46. In particular, in addition to or instead of a processor, such as a central processing unit, and memory, the processing circuitry 42 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure the WD with a downlink reference signal configuration and a channel state information, CSI, measurement configuration.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further include software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a prediction unit 34 which is configured to perform at least one temporal beam prediction based at least in part on the at least one measurement.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or includes a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as configuration unit 32, and prediction unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

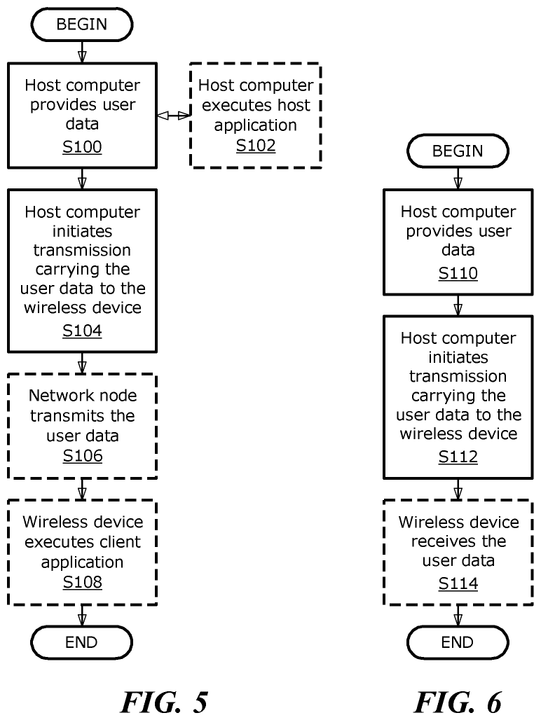

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

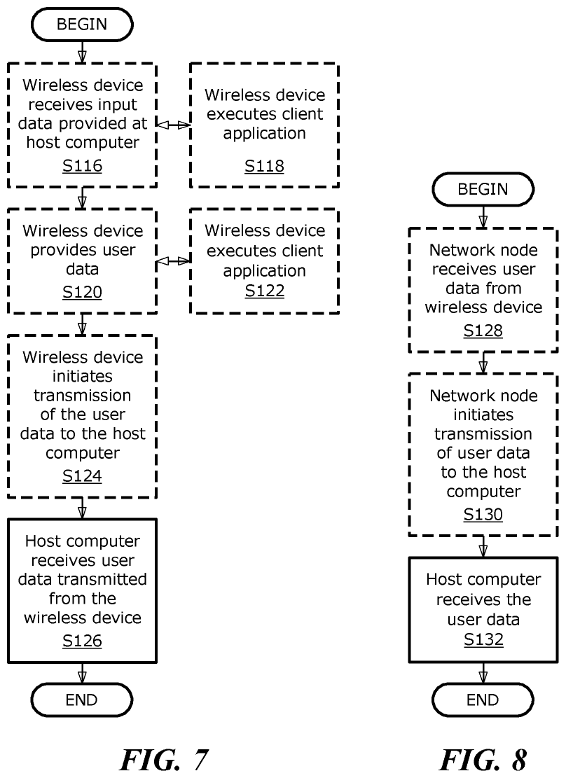

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

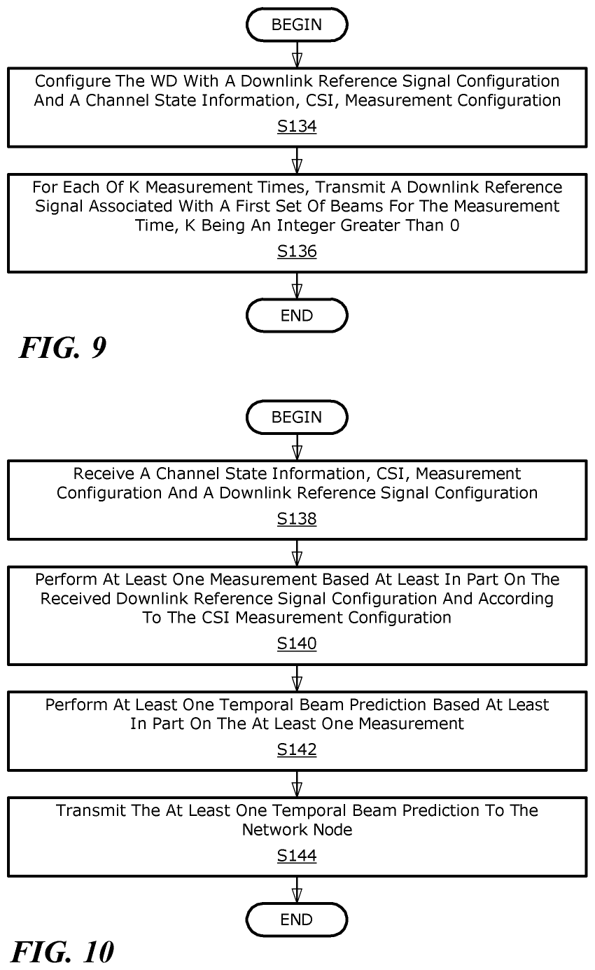

FIG. 9 is a flowchart of an example process in a network node 16 for measurement configurations for wireless device (WD)-sided time domain beam predictions. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the WD with a downlink reference signal configuration and a channel state information, CSI, measurement configuration (Block S134). The process also includes, for each of K measurement times, transmitting a downlink reference signal associated with a first set of beams for the measurement time, K being an integer greater than 0 (Block S136).

In some embodiments, the method includes receiving at least one temporal beam prediction for a second set of beams. In some embodiments, the first and second sets of beams at least partially overlap. In some embodiments, the temporal beam prediction is based on received signal measurements.

FIG. 10 is a flowchart of an example process in a wireless device 22 according to some embodiments of the present disclosure. One or more blocks described herein may be performed by one or more elements of wireless device 22 such as by one or more of processing circuitry 84 (including the prediction unit 34), processor 86, radio interface 82 and/or communication interface 60. Wireless device 22 such as via processing circuitry 84 and/or processor 86 and/or radio interface 82 is configured to receive a channel state information, CSI, measurement configuration and a downlink reference signal configuration (Block S138). The process also includes performing at least one measurement based on the received downlink reference signal configuration and according to the CSI measurement configuration (Block S140). The process further includes performing at least one temporal beam prediction based at least in part on the at least one measurement (Block S142). The process also includes transmitting the at least one temporal beam prediction to the network node (Block S144).

In some embodiments, the at least one temporal beam prediction is based at least in part on a received signal strength for a beam. In some embodiments, the at least one temporal beam prediction includes predicting at least one beam from a first set of beams swept at K different measurement times. In some embodiments, the method also includes reporting a beam prediction capability of the WD.

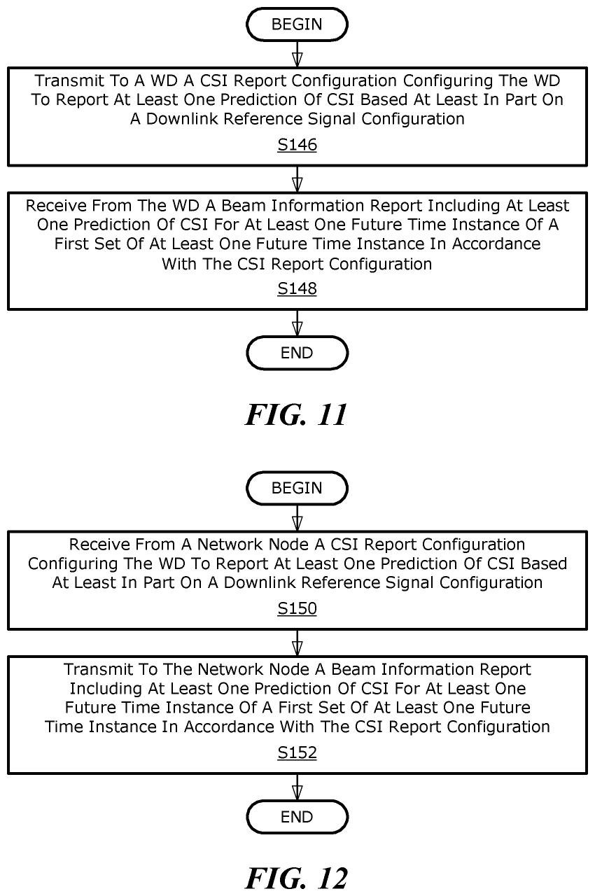

FIG. 11 is a flowchart of an example process in a network node 16 for measurement configurations for wireless device (WD)-sided time domain beam predictions. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to transmit to a WD 22 a CSI report configuration configuring the WD 22 to report at least one prediction of a beam from the set A of beams based on a downlink reference signal configuration associated with the set B of beams (Block S146). The method includes receiving from the WD 22 a beam information report including at least one prediction of a beam from the set A of beams for at least one future time instance of a first set of at least one future time instance in accordance with the CSI report configuration (Block S148).

According to this aspect, in some embodiments, the CSI report configuration further includes an indication of the at least one future time instance for the at least one beam prediction. In some embodiments, the at least one future time instance includes a plurality of future time instances that are equally distributed in time. In some embodiments, a first subset of the first set of future time instances is separated from a second subset of the first set of future time instances by a gap. In some embodiments, the beam information report includes an instantaneous beam report. In some embodiments, the CSI report configuration includes a beam prediction configuration indicating at least one beam for performing the at least one beam prediction. In some embodiments, the beam prediction configuration indicates a prediction window for which beam predictions are determined. In some embodiments, the beam prediction configuration indicates a plurality of prediction times for which beam predictions are determined. In some embodiments, the beam prediction configuration indicates a first set of prediction times for a first set of beam predictions in a first window and a second set of prediction times for a second set of beam predictions in a second window. In some embodiments, the method includes receiving from the WD 22 a beam prediction capability including at least one of prediction window parameters, measurement window parameters and a delay between a measurement window and a prediction window.

FIG. 12 is a flowchart of an example process in a wireless device 22 according to some embodiments of the present disclosure. One or more blocks described herein may be performed by one or more elements of wireless device 22 such as by one or more of processing circuitry 84 (including the prediction unit 34), processor 86, radio interface 82 and/or communication interface 60. Wireless device 22 such as via processing circuitry 84 and/or processor 86 and/or radio interface 82 is configured to receive from the network node 16 a CSI report configuration configuring the WD 22 to report at least one prediction of a beam from the Set A of beams based on a downlink reference signal configuration associated with a set B of beams (Block S150). The method also includes transmitting to the network node 16 a beam information report including at least one prediction of a beam from the Set A of beams for at least one future time instance of a first set of at least one future time instance in accordance with the CSI report configuration (Block S152).

According to this aspect, in some embodiments, the CSI report configuration further includes an indication of the at least one future time instance for the at least one beam prediction. In some embodiments, the at least one future time instance includes a plurality of future time instances that are equally distributed in time. In some embodiments, a first subset of the first set of future time instances is separated from a second subset of the first set of future time instances by a gap. In some embodiments, the beam information report includes an instantaneous beam report. In some embodiments, the CSI report configuration includes a beam prediction configuration indicating at least one beam for performing the at least one beam prediction. In some embodiments, the beam prediction configuration indicates a prediction window for which beam predictions are determined. In some embodiments, the beam prediction configuration indicates a plurality of prediction times for which beam predictions are determined. In some embodiments, the beam prediction configuration indicates a first set of prediction times for a first set of beam predictions in a first window and a second set of prediction times for a second set of beam predictions in a second window. In some embodiments, the method includes transmitting a beam prediction capability including at least one of prediction window parameters, measurement window parameters and a delay between a measurement window and a prediction window.

Having described the general process flow of arrangements of the disclosure and having provided examples of hardware and software arrangements for implementing the processes and functions of the disclosure, the sections below provide details and examples of arrangements for providing measurement configurations for wireless device (WD)-sided time domain beam predictions.

As used herein, a time domain beam prediction (TDBP) or a temporal beam prediction (TBP) AI/ML model may be viewed as a functionality or part of a functionality that is related to time domain beam prediction and is deployed, implemented, configured and/or defined in a WD 22.

A TDBP/TBP artificial intelligence (AI)/machine learning (ML) model may be defined as a feature, or part of a feature, that is implemented and supported in a WD 22, and the WD 22 may indicate the feature version to a network node 16 (e.g., a gNB). If the AI/ML model is updated, the feature version may be changed by the WD 22. The AI/ML model is understood to be any trainable ML algorithm including but not limited to, for example, artificial neural networks, decision trees, random forests, nearest neighbors, and support vector machines.

An TDBP/TBP AI/ML-model may correspond to a function that receives one or more inputs (e.g., channel measurements on a set B of beams) at time instances within T1 and outputs one-or-more decisions, estimates, or prediction(s) of a certain type (e.g., CSI for a set A of beams, or top-K predicted beams from set A of beams) at time instances within T2.

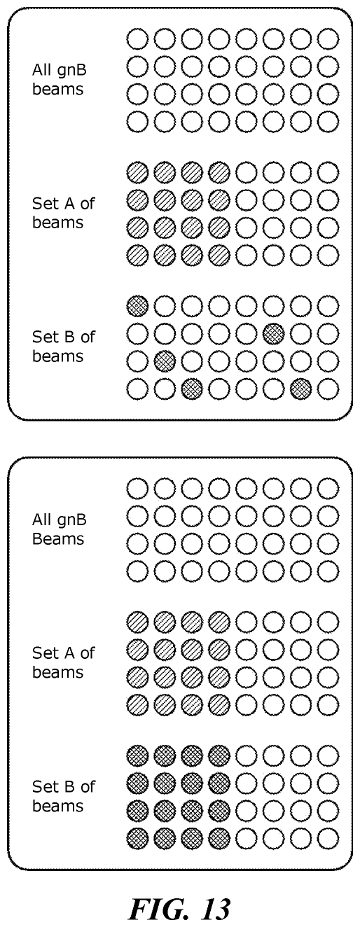

FIG. 13 illustrates a schematic example of the Set A of beams and the Set B of beams, which are used herein. In the left figure the Set A of beams are different than Set A of beams, and in the right example, the Set A of beams are the same as Set B of beams. The Set A and/or Set B of beams may include all the network node beams or a subset of the network node beams.

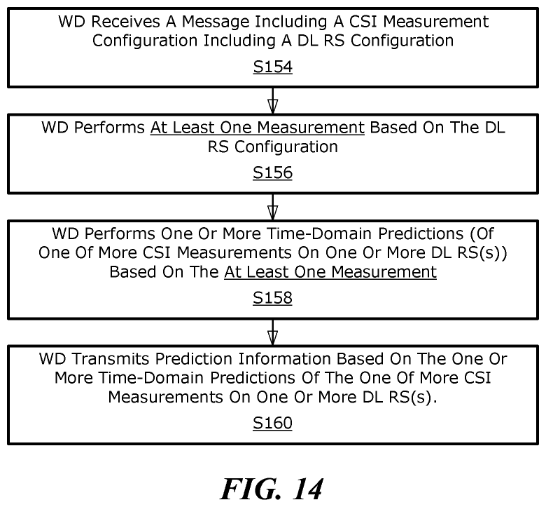

FIG. 14 is a flowchart of an example process in a wireless device. In Step S154, the WD 22 receives (and network node 16 transmits) a set of DL RSs transmitted by the network, for example, in different spatial directions and/or using different spatial filters and/or using different beams. These different DL RSs may be CSI-RSs transmitted in a beam sweep, using the Set B of beams K times during a time window T1. In Step S156, the WD 22 performs one or more measurements (e.g., CSI measurements) on at least one of the K time occasions in which the CSI-RSs in the beam sweep using the Set B of beams are being transmitted. Based on the measurements of at least one of the K beam sweeps, in Step S158, the WD 22 predicts the at least one beam from a set A of beams for F future time instances. In Step S160, the WD 22 reports the predictions to the network node 16, e.g., the beam in the set A with the strongest RSRP value. The WD 22 may also be configured with the set A of beams which are to be predicted for each of the F future time instances without any further beam sweeps, which will reduce the beam management overhead and measurement complexity.

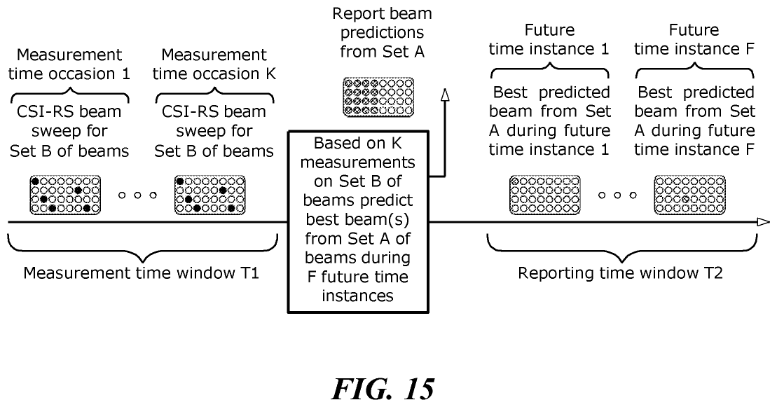

FIGS. 15-17 are examples that illustrate timing associated with the steps performed by the WD 22 and the network node 16 as disclosed herein.

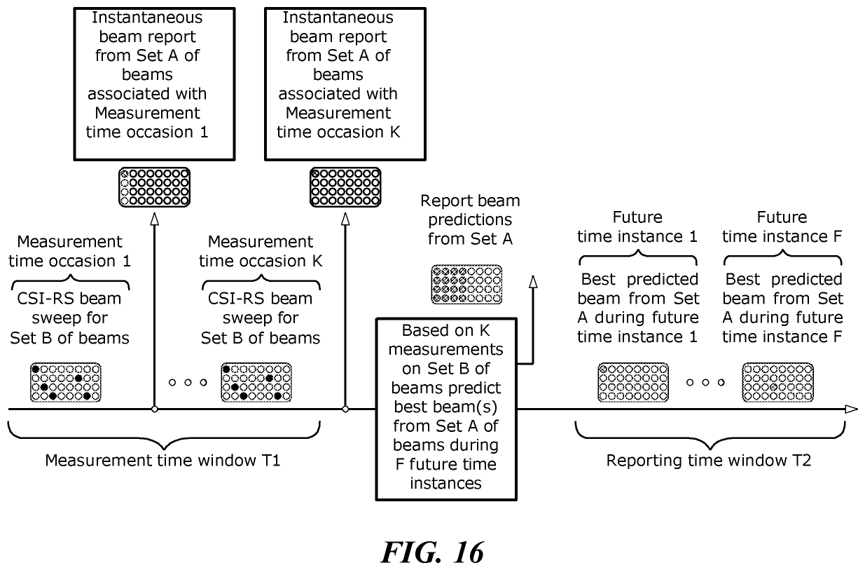

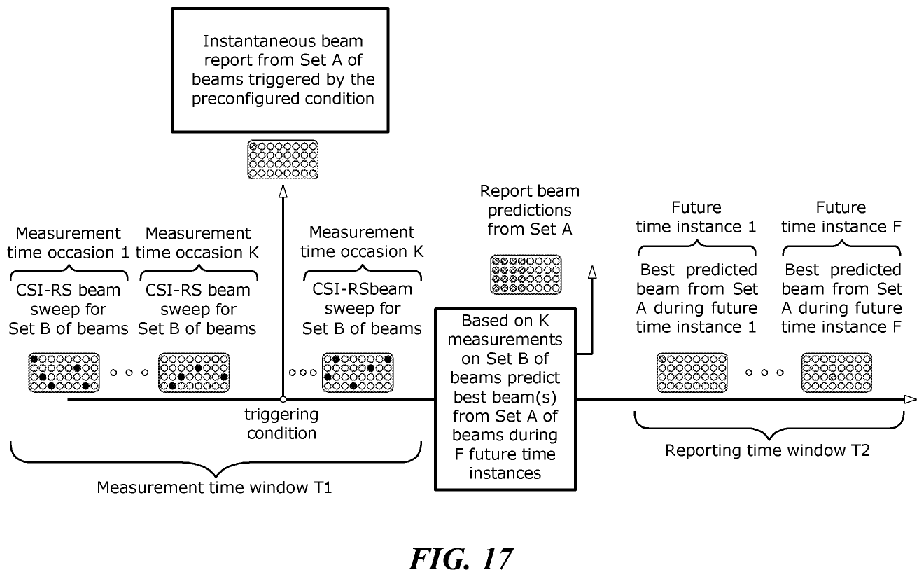

As may be seen in FIG. 15, it will take some time for the WD 22 to attain the reported beam predictions (at least T1+additional processing and reporting delay). In case the network would like to schedule the WD 22 before that, the network will not know which gNB beam to use, unless a separate legacy beam sweep procedure is triggered at the same time, which would require additional signaling overhead. To solve this, in some embodiments, the WD 22 may be indicated to report the best instantaneous beam for all or subset of all K measurement time occasions, which is schematically illustrated in FIG. 16. In some embodiments, this instantaneous beam reporting may be dynamically indicated in the DCI triggering the beam prediction report. In some embodiments, the instantaneous beam reporting is only done once, during the first measurement time window T1 (since after that the predicted beam report may be done with such periodicity such that the network always will have knowledge about suitable gNB beams). In some embodiments, the instantaneous beam reporting may be dynamically triggered by the preconfigured conditions indicated by the network via RRC configuration, MAC-CE or DCI, which is schematically illustrated in FIG. 17.

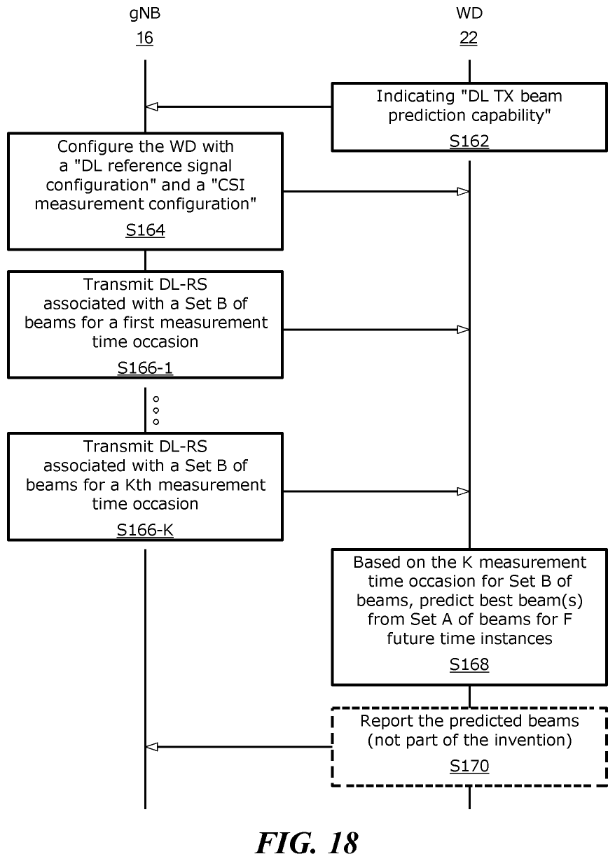

FIG. 18 is a flowchart of an example process, showing the interactions of the WD 22 and the network node 16. In Step S162, the WD 22 reports, for example during WD 22 capability signaling, support for performing beam predictions from a Set A of network node beams for F future time instances based on K measurements on a Set B of network node beams. The WD 22 capability signaling (“DL TX beam prediction capability”) can, for example, include one or more of the following information:
Support of the feature to report beams in future time instances;
Maximum number of future time instances (F) to report predicted beams for;
Maximum length of time window T2;
Minimum length of time window T2;
Minimum time delay between last received DL-RS to perform measurement on for beam prediction, and the time for reporting the predicted beams to the network node 16;
Maximum number of Measurement time occasions (K) of DL reference signals from Set B of beams during a time window T1;
Minimum number of Measurement time occasions (K) of DL reference signals from Set B of beams during a time window T1;
Maximum length of time window T1; and/or
Minimum length of time window T1.

In Step S164, the network node 16 indicates the relevant configurations for the time domain beam prediction, for example a “DL reference signal configuration”, a “CSI measurement configuration”. The “DL reference signal configuration” can, for example, include one or more of:
Resource Setting (i.e., CSI-ResourceConfig as specified in 3GPP Technical Standard (TS) 38.311);
CSI-RS resource sets (i.e., NZP-CSI-RS-ResourceSet as specified in 3GPP TS 38.311);
CSI-RS resources (i.e., NZP-CSI-RS-Resource as specified in 3GPP TS 38.311);
New potential DL-RS resource configuration for 6G The “CSI measurement configuration” may for example include one or more of:
Report Setting (i.e., CSI-ReportConfig as specified in 3GPP TS 38.311); and/or
New potential CSI measurement/report configuration for 6G.

The CSI report configuration may for example indicate the definition of the future time instances, or the CSI report configuration may indicate to the WD 22 to determine and report the definition of the future time instances. The CSI report configuration may also indicate whether instantaneous beam reports should be performed or not in addition to the predicted beam reports. The CSI report configuration may indicate whether instantaneous beam reports should be performed or not if the triggering condition is met.

In Step S166-1 through S166-K, the network node 16 performs K Set B beam sweeps by transmitting a set of DL reference signals associated with the Set B of beams at K different times.

In Step S168, the WD 22 predicts the best Y beams from Set A of beams for F future time instances based on measurements from the K Set B beam sweeps.

In Step S170, the WD 22 reports the predicted beams to the network node 16.

In some embodiments, the message including the CSI measurement configuration (or CSI measurement prediction configuration), including a DL Reference Signal (RS) configuration, based on which the time-domain predictions are performed, may correspond to an RRC Reconfiguration message (e.g., RRCReconfiguration, as defined in 3GPP TS 38.331). The message may be received when the WD 22 transitions to RRC_CONNECTED (or other form of Connected state) and/or after the WD 22 reports a capability to the network (denoted in the document “DL TX beam prediction capability”), indicating that the WD 22 is capable of reporting beams in future time instances based on the DL RS configuration. The message may correspond to an RRC Resume message (e.g., RRCResume, as defined in 3GPP TS 38.331), received when the WD 22 transitions to RRC_CONNECTED mode from RRC_INACTIVE mode. The message may be generated by the network after the network retrieves a capability (denoted in the document “DL TX beam prediction capability”), indicating that the WD 22 is capable of reporting beams in future time instances based on the DL RS configuration.

In some embodiments, the CSI measurement configuration (or CSI measurement prediction configuration), including a DL RS configuration, based on which the time-domain predictions are performed, may be provided to the WD 22 as part of a Serving Cell Configuration (e.g., in the IE ServingCellConfig, for an SpCell (i.e., primary cell (Pcell) and/or primary serving cell (PSCell) or a secondary cell (Scell).

In some embodiments, if the CSI measurement configuration (or CSI measurement prediction configuration) is provided in a Serving Cell Configuration, the DL RS configuration configures DL RSs of that Serving Cell to be measured by the WD 22 The set B of beams is a set of beams of that Serving Cell in which the configuration is included. The DL RSs (i.e., the Set B of beams) may be indicated to the WD 22 with one or more beam identifiers and/or DL RS identifiers, such as SSB indices in case the DL RS of set B is of RS type SSB, or CSI-RS resource identifiers, in case the DL RS of set B is of RS type CSI-RS. For example, if the DL RS configuration includes SSB index (1), SSB index (3), and SSB index (7), the WD 22 knows these are SSBs of that Serving Cell and performs at least one measurement on that first set of DL RSs (Set B).

In some embodiments, if the CSI measurement configuration (or CSI measurement prediction configuration) is provided in the Serving Cell Configuration, the DL RS configuration may configure DL RSs of a serving cell in the same cell group of that Serving Cell Configuration, The set B of beams configured in that Serving Cell may be beams of that Serving Cell (e.g., Pcell) or another serving cell in the same cell group (e.g., an Scell of the Master Cell Group). In that case, the DL RSs (i.e., the Set B of beams) may be indicated to the WD 22 with one or more beam identifiers and/or DL RS identifiers associated to a serving cell index or identity. For example, SSB indices may be indicated in case the DL RS of set B is of RS type SSB associated to a serving cell index. Or, CSI-RS resource identifiers associated to a serving cell index may be indicated, in case the DL RS of set B is of RS type CSI-RS. In other words, if the DL RS configuration includes SSB index (1), SSB index (3), and SSB index (7) associated to a serving cell index 4, the WD 22 knows these are SSBs of the Serving Cell in that cell group whose serving cell index is set to 4. Then, the WD 22 performs at least one measurement on that first set of DL RSs (Set B) of that serving cell with serving cell index 4.

In some embodiments, the CSI measurement configuration (or CSI measurement prediction configuration) may include a reference or a pointer to a DL RS configuration. Based on the indicated DL RS configuration, the time-domain predictions are performed. The CSI measurement configuration (or CSI measurement prediction configuration) may be provided to the WD 22 as part of a Serving Cell Configuration in the information element (IE), ServingCellConfig for an SpCell (i.e., Pcell and/or PSCell) or an Scell). The CSI measurement configuration may be for a first Serving Cell (e.g., Pcell), and may include the reference or the pointer to the DL RS configuration (e.g., resource configuration index) in another Serving Cell configuration for a serving cell in the same cell group.

In some embodiments, the CSI measurement configuration (or CSI measurement prediction configuration) includes the IE CSI-MeasConfig as defined in 3GPP TS 38.331 and/or a new IE defined for including prediction configuration e.g., CSI-PredictionMeasConfig.

In some embodiments, the reporting configuration (e.g., CSI reporting prediction configuration and/or a CSI prediction reporting configuration) based on which the WD 22 may transmit predicted information to the network, may be provided to the WD 22 as part of a Serving Cell Configuration (e.g., in the IE ServingCellConfig, for an SpCell (i.e., PCell and/or PSCell) or an SCell).

In some embodiments, if the reporting configuration (e.g., CSI reporting prediction configuration and/or a CSI prediction reporting configuration) based on which the WD 22 transmits predicted information to the network, is provided in a Serving Cell Configuration, the WD 22 may transmit the predicted information to that serving cell. In other words, the WD 22 transmits the predicted information to an Uplink channel (e.g., Physical Uplink Control Channel—PUCCH, and/or Physical Uplink Shared Channel—PUSCH) of that serving cell, wherein the Uplink channel configuration is also part of the Serving Cell Configuration.

In some embodiments, the set A of DL RSs (i.e., the Set A of beams) in which the WD 22 performs the one or more time-domain predictions of one of more CSI measurements may be indicated to the WD 22 with one or more beam identifiers and/or DL RS identifiers, such as SSB indices in the case the DL RS of set A is of RS type SSB, or CSI-RS resource identifiers, in the case the DL RS of set A is of RS type CSI-RS.

In some embodiments, if the reporting configuration (e.g., CSI reporting prediction configuration and/or a CSI prediction reporting configuration) based on which the WD 22 transmits predicted information to the network is provided in the Serving Cell Configuration of a first serving cell (e.g., PCell, PSCell, SpCell as defined in 3GPP TS 38.300 and/or 3GPP TS 38.331), the reporting configuration may indicate the set of one or more DL RSs (Set A) of that serving cell or any other serving cell (e.g., an SCell of the Master Cell Group, or SCell of the Secondary Cell Group) as the set in which the WD 22 performs the one or more time-domain predictions of one of more CSI measurements on a set of one or more DL RS(s) (Set A). In that case, the set A of beams (or DL RS indices) may be indicated to the WD 22 with one or more beam identifiers and/or DL RS identifiers associated to a serving cell index or identity; For example, SSB indices in the case the DL RS of set A is of RS type SSB associated a serving cell index, or CSI-RS resource identifiers associated to a serving cell index, in the case the DL RS of set A is of RS type CSI-RS. In other words, if the DL RS configuration includes SSB index (1), SSB index (3), and SSB index (7) associated to a serving cell index 4, the WD 22 knows these are SSBs of the Serving Cell in that cell group whose serving cell index is set to 4; then, the WD 22 performs at least one time-domain prediction on that first set of DL RSs (Set A) of that serving cell with serving cell index 4.

In some embodiments, if the reporting configuration (e.g., CSI reporting prediction configuration and/or a CSI prediction reporting configuration) based on which the WD 22 transmits predicted information to the network is provided in the Serving Cell Configuration of a first serving cell, the WD 22 performs the one or more time-domain predictions of one of more CSI measurements on a set of one or more DL RS(s) (Set A) of that first serving cell e.g., SSB indices of that first serving cell. For example, if the reporting configuration includes SSB index (1), SSB index (3), and SSB index (7) as the Set A the WD 22 knows these are SSBs of that Serving Cell and perform at least one time-domain prediction on that first set of DL RSs (Set A).

In some embodiments, the reporting configuration (e.g., CSI reporting prediction configuration and/or a CSI prediction reporting configuration), based on which the WD 22 transmits predicted information to the network, comprises an indication of a DL RS configuration. The DL RS configuration comprises an indication of one or more DL RSs (denoted Set B) which the WD 22 uses for performing one or more measurements (e.g., CSI measurements, like SS-RSRP, L1 RSRP). Based on this, the WD 22 performs the one or more time-domain predictions of CSI measurements of the set A. The indication of the DL RS configuration comprises at least one or more DL RS indices (e.g., SSB indices and/or CSI-RS resource identifiers, beam identifiers). In some embodiments, the WD 22 performs one or more measurements on Set B (e.g., SSB indices), according to the DL RS configuration; based on the measurement the WD 22 performs the one or more time-domain predictions on Set A (e.g., SSB indices). Based on the time-domain predictions of CSI measurements the WD 22 derives the predicted information.

There may be three kinds of cells: i) the serving cell of Set B, i.e., the cell of the DL RSs in which the WD 22 perform the measurements; ii) the serving cell of Set A, i.e., the cell of the DL RSs which the WD 22 perform the one or more time-domain predictions; ii) the serving cell in which the predicted information is transmitted. These cells may be the same or different.

In some embodiments, if the reporting configuration is included in the Serving Cell Configuration of a first serving cell, the WD 22 transmits the predicted information in that first serving cell. That Serving Cell Configuration may include the indication of Set A, to be predicted, e.g., Set A=SSB index (7), SSB index (13), SSB index (35). These are SSBs of that first serving cell. That Serving Cell Configuration also may include the DL RS configuration, configuring the Set B in which the WD 22 performs one or more measurements e.g., Set B=SSB index (1), SSB index (5), SSB index (7). These are also SSBs of that first serving cell; based on the measurements of Set B, the WD 22 predicts the one or more time-domain predictions of the Set A. In this example, all three cells are the same serving cell. The Set A and B may also be the same or different, though they are from the same serving cell.

In some embodiments, if the reporting configuration is included in the Serving Cell Configuration of a first serving cell, the WD 22 transmits the predicted information in that first serving cell. That Serving Cell Configuration may also include the indication of Set A, to be predicted, e.g., Set A=SSB index (7), SSB index (13), SSB index (35). These are SSBs of that first serving cell. However, the Set B in which the WD 22 performs one or more measurements, e.g., Set B=SSB index (1), SSB index (5), SSB index (7). These may be associated to a different serving cell (e.g., from the same cell group), so that the indication of the DL RSs of Set B may include the DL RS indices associated to a serving cell index (of a serving cell in the same cell group in which the reporting configuration is configured).

In some embodiments, the reporting configuration (e.g., CSI reporting prediction configuration and/or a CSI prediction reporting configuration) based on which the WD 22 transmits predicted information to the network, may include an instance or a set of instances (e.g., in a list) of an Information Element (IE) within a CSI measurement configuration e.g., within the IE CSI-MeasConfig as defined in 3GPP TS 38.331. This may be useful, for example, in the case in which the WD 22 includes predicted information in a CSI report, together with CSI measurements.

In some embodiments, the reporting configuration corresponds to the IE CSI-ReportConfig (nested within CSI-MeasConfig), which is enhanced to include configurations and/or fields and/or parameters and/or IEs for configuring the reporting of the predicted information.

In some embodiments, the reporting configuration corresponds to a list of instances of the IE CSI-ReportConfig (SEQUENCE OF in ASN.1 notation, e.g., nested within CSI-MeasConfig), which is enhanced to include configurations and/or fields and/or parameters and/or IEs for configuring the reporting of the predicted information, according to method disclosed herein.

In some embodiments, the reporting configuration corresponds to an instance or a set of instances of an IE defined for configuring prediction reports, e.g., CSI-PredictedReportConfig, including configurations for reporting predicted information (e.g., nested within CSI-MeasConfig).

In some embodiments, the reporting configuration (e.g., CSI reporting prediction configuration and/or a CSI prediction reporting configuration) based on which the WD 22 transmits predicted information to the network may include an instance or a set of instances (e.g., in a list) of an Information Element (IE) within a CSI prediction measurement configuration e.g., within anew IE CSI-PredictionMeasConfig as defined in 3GPP TS 38.331. This may be useful, for example, in the case in which the WD 22 transmits predicted information in a report which does not include CSI measurements.

In some embodiments, the reporting configuration corresponds to the IE CSI-ReportConfig (nested within CSI-PredictionMeasConfig), which is enhanced to include configurations and/or fields and/or parameters and/or IEs for configuring the reporting of the predicted information.

In some embodiments, the reporting configuration corresponds to a list of instances of the IE CSI-ReportConfig (SEQUENCE OF in ASN.1 notation, e.g., nested within CSI-PredictionMeasConfig), which is enhanced to include configurations and/or fields and/or parameters and/or IEs for configuring the reporting of the predicted information.

In some embodiments, the reporting configuration corresponds to an instance or a set of instances of an IE defined for configuring prediction reports, e.g., CSI-PredictionReportConfig, including configurations for reporting predicted information (e.g., nested within CSI-PredictionMeasConfig).

In a set of embodiments, the reporting configuration (e.g., CSI reporting prediction configuration and/or a CSI prediction reporting configuration) based on which the WD 22 transmits predicted information to the network may include one or more of:
A reporting prediction configuration identifier e.g., reportConfigId. This identifier is an integer which refers to the reporting prediction configuration, in case in another message the WD 22 may be instructed to delete and/or modify the reporting configuration.
An indication of in which of the configured serving cell(s) (of the Cell Group in which the reporting configuration is included e.g., PCell of MCG, one of the SCells of the MCG) the configuration of the DL RSs/beams of Set A (i.e., the DL RSs/beams to be predicted) is to be found e.g., if Set A belongs to a serving cell which is not be the same.
   In one option, the indication is a serving cell index, associated to one of the configured serving cells in that cell group.
   In one option, the absence of that indication indicates to the WD 22 that the configuration of the DL RSs/beams of Set A are to be found in that same serving cell configuration in which the reporting configuration is included.
An indication of in which of the configured serving cell(s) (of the Cell Group in which the reporting configuration is included e.g., PCell of MCG, one of the SCells of the MCG) the configuration of the DL RSs/beams of Set B (i.e., the DL RSs/beams which the WD 22 perform measurements on in order to perform the one or more time-domain predictions of the Set A) is to be found e.g., if Set B belongs to a serving cell which is not be the same including the reporting configuration. In one option, the absence of that indication indicates to the WD 22 that the configuration of the DL RSs/beams of Set B are to be found in that same serving cell configuration in which the reporting configuration is included.
An indication of the DL RS configuration for Set A, such as a resource prediction configuration identifier, associated to one or more DL RS identifiers e.g., SSB indices, and/or CSI-RS resource identifiers, beam identifiers. The identifier refers to a resource prediction configuration included in the Serving Cell Configuration (e.g., IE ServingCellConfig) of one of the serving cells in the same cell group in which the reporting configuration is included.
A reporting configuration type and associated configuration, defining how the predicted information is to be transmitted. The report type and associated configuration(s) include one or more of:

### Periodic

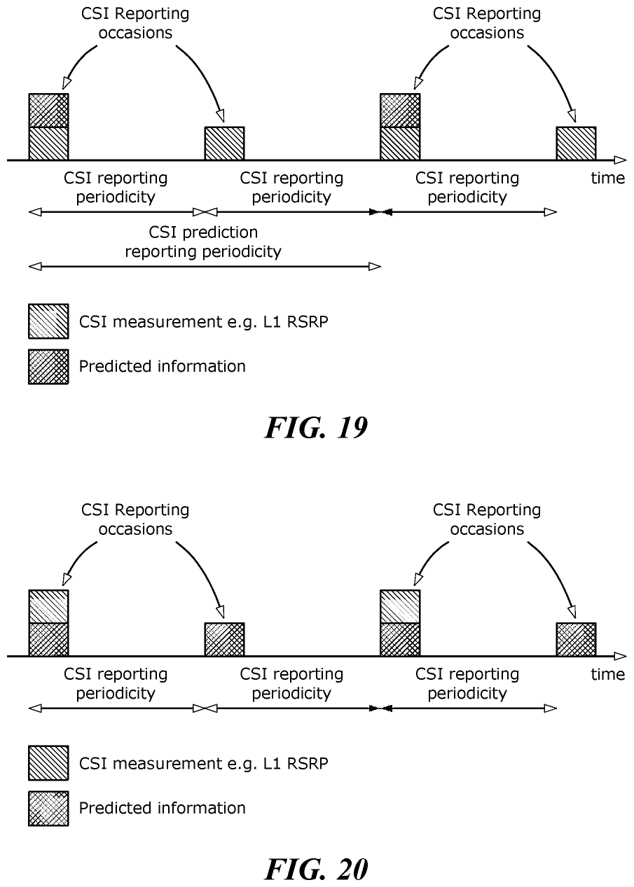

If report type is set to ‘periodic’, the WD 22 transmits predicted information periodically to the network, according to a “periodicity” (part of the configuration) expressed in time units such as (slots, OFDM symbols, etc.).
If the predicted information is to be included in a periodic CSI prediction report, which does not include CSI measurements, such as the SS-RSRP of an SSB (associated to an SSB index), the configured periodicity indicates how often the WD 22 transmits the predicted information.
If the predicted information is to be included in a periodic CSI report, which also may include CSI measurements, such as the SS-RSRP of an SSB (associated to an SSB index), there may be different possibilities for the configuration of the periodicity.
   In one option, the periodicity for reporting the predicted information (CSI prediction reporting periodicity) is the same as the CSI reporting periodicity, so that in each period the WD 22 may include both CSI measurement(s) and predicted information e.g., for the same beam/DL RS/SSB index. In that case, for example, the parameter “periodicity” within the reporting configuration of a CSI report for beam reporting is used for reporting both the CSI measurement(s) and the predicted information periodically. This solution simplifies the design and assumes both information is useful to the network at any reporting occasion.
   In one option, the periodicity for reporting the predicted information is different from the CSI reporting periodicity, for example, the periodicity for reporting predicted information is longer. This means that out of all occasions of the CSI reports transmitted periodically, only a subset will include the predicted information, while all the occasions will include the actual CSI measurements. The reasoning is that prediction may be needed less often to the network than the actual CSI measurements for beam report, to support beam switching and/or TCI state activation/deactivation. One example is show below for CSI reports including only CSI measurements transmitted more often than CSI reports including both CSI measurements and predicted information. In this case, the CSI prediction reporting periodicity may be configured as a subset of the CSI reporting periodicity e.g., CSI prediction reporting periodicity=2×CSI reporting periodicity. See FIG. 19.
   In one option, the periodicity for reporting the predicted information is the CSI reporting periodicity, but CSI measurements are included less often i.e., there is a longer periodicity for including CSI measurements in the actual CSI report. For example, the periodicity for reporting predicted information is shorter i.e., predicted information is transmitted more often than the actual CSI measurements, for the same reporting configuration. This means that out of all occasions of the CSI reports transmitted periodically, only a subset will include the CSI measurements, while all the occasions will include the predicted information. The reasoning is that in the occasions the WD 22 would not be required to perform CSI measurements, i.e., the amount of energy consumption due to CSI measurements may be reduced. In addition, fewer DL RSs occasions may be configured compared to the occasions in which reports are needed, so that the transmission overhead of these DL RSs may be reduced. An example is shown in FIG. 20.
The reporting configuration may include the configuration of the UL control channel in which the WD 22 is to transmit the predicted information periodically, such as the type of UL control channel (e.g., PUSCH, PUCCH, RACH, or any other UL channel) and the actual resource configuration (e.g., indication in the time and frequency domain where the UL resources are reserved for that purpose), such as a UL control resource list.

### Aperiodic:

If report type is set to ‘aperiodic’, the WD 22 transmits predicted information to the network upon reception of a triggering command, indicating a reporting configuration (e.g., reporting configuration identity), wherein the triggering command corresponds to a MAC CE and/or a Downlink Control Indication in PDCCH.
In some embodiments, when the WD 22 receives the triggering command the WD 22 has available predicted information and/or available time-domain prediction(s) of CSI measurements to be used as input to derive the predicted information, so that the command triggers the WD 22 to transmit the indication report in the reporting occasion.
In some embodiments, when the WD 22 receives the triggering command the WD 22 derives the predicted information and/or performs the one or more time-domain prediction(s) of CSI measurements to be used as input to derive the predicted information, and then include in the report to be transmitted to the network.
In some embodiments the command indicates a reporting timing offset (e.g., an integer in the command pointing to a value configured in the reporting configuration) indicating the time occasion in which the WD 22 is to transmit the predicted information and/or the CSI report, e.g., in terms of number of slots, subframes, OFDM symbols, etc.
In some embodiments the command indicates a prediction timing offset (e.g., an integer in the command pointing to a value configured in the reporting configuration) indicating at least one (e.g., the first) future time instance in which the network wants the prediction. Based on the indication, the WD 22 may include in the report the prediction information for the indicated prediction timing offset
   In one option, the prediction timing offset is an offset from the reporting timing offset. For example, if the reporting timing offset indicates X1 slots, and the prediction timing offset indicate X2 slots, the WD 22 transmits the report to the network X1 slots after it has received the command, and may include the predicted information of for the future time instance X1+X2+time the command was received.
   In another option, the prediction timing offset is an offset from the timing the WD 22 receives the command.
The reporting configuration may include the configuration of the UL control channel in which the WD 22 is to transmit the predicted information upon reception of the command, such as the type of UL control channel (e.g., PUSCH, PUCCH, RACH, or any other UL channel) and the actual resource configuration (e.g., indication in the time and frequency domain where the UL resources are reserved for that purpose), such as a UL control resource list.

### Semi-Persistent:

If report type is set to ‘semi Persistent’, the WD 22 transmits predicted information to the network periodically upon reception of a triggering command, indicating a reporting configuration (e.g., reporting configuration identity), wherein the triggering command corresponds to a MAC CE and/or a Downlink Control Indication in PDCCH.
Similar parameters as in periodic report (except that WD 22 transmits periodically after reception of the triggering command).
The reporting configuration may include the configuration of the UL control channel in which the WD 22 is to transmit the predicted information upon reception of the command, such as the type of UL control channel (e.g., PUSCH, PUCCH, RACH, or any other UL channel) and the actual resource configuration (e.g., indication in the time and frequency domain where the UL resources are reserved for that purpose), such as a UL control resource list.
An indication of the first future time instance:
   In some embodiments, the indication is a gap or offset (e.g., in number of slots) from the associated reporting occasion. For example, if the reporting occasions is in slot X0, and the indication is X1, the WD 22 reports in slot X0 the predicted information for the future time unit X0+X1.
An indication of the length of the future time instance (F)
   In some embodiments, the indication is an integer indicating a number of future time instances for which the WD 22 includes in a report to be transmitted. For example, if F is configured, and the reporting occasions is in slot X0, and the indication is X1, the WD 22 reports in slot X0 the predicted information for the future time unit X0+X1, and for other F−1 future time unit(s). The exact timing between future time instances is defined by the gap between the first and subsequence, which may also be part of the configuration or be pre-determined (e.g., hard coded at the WD 22, if defined in the specifications).
An indication of T2 e.g., window for the future time instances
Reporting quantity to be predicted, such as one or more of. Received Signal Strength, RSSI, RSRP, RSRA, SINR, SS-RSRP (RSRP of one or more SSBs, associated to one or more SSB indices), SS-RSRQ (RSRQ of one or more SSBs, associated to one or more SSB indices), SS-SINR, CSI-RSRP (RSRP of one or more CSI-RS resources, associated to one or more CSI-RS resource identifiers),
Group reporting e.g., to indicate that time-domain prediction information for more than one beam and/or RS index and/or RS resource identifier is to be reported i.e., included in a CSI report for time-domain predictions.
Number of groups reported.

In some embodiments, the WD 22 performs one or more time-domain predictions of one of more CSI measurements on a second set of one or more DL RS(s) (Set A) based on the at least one measurement performed based on the DL RS configuration, wherein the second set of one or more DL RS(s) (Set A), to be predicted, is indicated to the WD 22, e.g., as a list of one of DL RS indices. In other words, the DL RS configuration is for a set B of beams, which may correspond to, i.e., DL RSs transmitted in B beams or spatial directions. For example, the DL RS configuration may be associated to e.g., SSB index (1), SSB index (3), and SSB index (7). The WD 22 may perform one or more time-domain predictions of one of more CSI measurements on a second set of one or more DL RS(s) (Set A) Set A may or may not overlap with Set B. Set A may be configured at the WD 22.

In some embodiments, Set A is the same as Set B, i.e., the DL RS configuration may include SSB index (1), SSB index (3), and SSB index (7), of a serving cell, and the WD 22 performs one or more time-domain predictions of one of more CSI measurements on SSB index (1), SSB index (3), and SSB index (7), of the same serving cell.

In some embodiments, Set A partially overlaps with Set B, i.e., the DL RS configuration may include SSB index (1), SSB index (3), and SSB index (7), of a serving cell, and the WD 22 performs the one or more time-domain predictions of one of more CSI measurements on SSB index (1), SSB index (12), and SSB index (17), of the same serving cell. In case Set A and Set B are different, the number of beams in the two sets may be the same or different.

In some embodiments, Set A differs from Set B, but they are still sets of beams of the same serving cell. For example, the DL RS configuration may include SSB index (1), SSB index (3), and SSB index (7), of a serving cell, and the WD 22 performs one or more time-domain predictions of one of more CSI measurements on SSB index (5), SSB index (12), and SSB index (17), of the same serving cell. In case Set A and Set B are different, the number of beams in the two sets may be the same or different.

In some embodiments, Set A has the same beam (or DL RS) indices as Set B, but these are beams of different serving cells, in the same cell group. For example, the DL RS configuration may include SSB index (1), SSB index (3), and SSB index (7), of a first serving cell (Pcell), and the WD 22 performs one or more time-domain predictions of one of more CSI measurements on SSB index (1), SSB index (3), and SSB index (7), of a different serving cell (e.g., an Scell of the Master Cell Group); and/or

In some embodiments, Set A has the same beam (or DL RS) indices as Set B, but these are beams of different serving cells, in different cell groups. For example, the DL RS configuration may include SSB index (1), SSB index (3), and SSB index (7), of a first serving cell (Pcell), and the WD 22 performs one or more time-domain predictions of one of more CSI measurements on SSB index (1), SSB index (3), and SSB index (7), of a different serving cell (e.g., an Scell of the Secondary Cell Group).

In some embodiments, the WD 22 performs one or more time-domain predictions of one of more CSI measurements on a second set of one or more DL RS(s) (Set A), where the second set of one or more DL RS(s) (Set A) is determined based on the DL RS configuration.

In some embodiments, the DL RS configuration indicates to the WD 22 one or more beams (e.g., one or more) and/or DL RSs (e.g., SSB indices and/or CSI-RS resource identities) transmitted by the network and are to be measured by the WD 22 and, the WD 22 performs the one or more time-domain predictions of one of more CSI measurements on that same set of beams indicated to the WD 22 (e.g., SSB indices and/or CSI-RS resource identities).

In some embodiments, the DL RS configuration indicates to the WD 22 one or more beams (e.g., one or more) and/or DL RSs (e.g., SSB indices and/or CSI-RS resource identities) which are transmitted by the network and which are to be measured by the WD 22. The WD 22 performs the one or more time-domain predictions of one of more CSI measurements on any beam and/or DL RSs and/or SSBs associated to the same cell, which may include the ones indicated to the WD 22. For example, if the DL RS configuration indicates SSB index (1), SSB index (3) and SSB index (7) of the Pcell the WD 22 may perform measurements on them, for examples, as follows: SS-RSRP for SSB index (1), SS-RSRP for SSB index (3) and SS-RSRP for SSB index (7). Based on these measurements, the WD 22 may perform time-domain predictions of one or more CSI measurements, such as L1-RSRP. The predictions may be for the same SSB indices, or for any other SSB index of the Pcell. SSBs of the same cell may be the SSBs encoding the same Physical Cell Identity (PCI) as the serving cell and/or transmitted in the same SSB frequency and/or having the same subcarrier spacing (SCS).

In some embodiments, the WD 22 performs the one or more time-domain predictions of one of more CSI measurements on a second set of one or more DL RS(s) (Set A) at least in one or more time occasions (1 to F time occasions). At least one time occasion is a time occasion for which the DL RSs are not being transmitted by the network, and hence, not being measured by the WD 22. In other words, there are time intervals or occasions in a given timeline of the WD 22 in which the WD 22 performs measurements and time intervals or occasions in which the WD 22 performs time-domain predictions. Also, these predictions may be obtained at a time occasions before the 1 to F time occasions. This enables the WD 22 to report to the network information regarding the quality of one or more beams (e.g., DL RSs of set A) at an earlier occasion, so that the network may take proactive actions. Such proactive actions may include one or more of re-configuring CSI measurements, proactively triggering a beam switching and/or a TCI state activation and/or a TCI state deactivation, re-configured Beam Failure Recovery (e.g., set of candidate beams), Beam Failure Detection and/or Radio Link Monitoring (e.g., set of beams which are to be monitored).

In some embodiments, the WD 22 performs one or more time-domain predictions of one of more CSI measurements on a second set of one or more DL RS(s) (Set A) and selects the best DL RS (or the best beam corresponding to the best DL RS), wherein the “best DL RS” of set A corresponds to one or more of:
DL RS in the Set A in which the predicted measurement has the strongest RSRP; In other words, at a given time instance (e.g., t0) after the WD 22 performed the measurements on the Set B, the WD 22 predicts RSRP values (e.g., SS-RSRP, L1 RSRP) of one or more DL RSs of set A based on these measurements. In other words the WD 22 predicts, i.e., the values these DL RSs of set A would have after a time period and after some measurement occasions. Then, the WD 22 selects the DL RS (and/or beam associated) with the strongest predicted RSRP value. When reported to the network, the strongest predicted value indicates to the network what is a good candidate beam (DL RS) at a future time instance. Based on this indication of the strongest predicted value, the network node 16 may perform reconfiguration of beam related parameters and/or activation or deactivation of beam related configurations e.g., the activation/deactivation of CSI measurement resource(s) and/or activation/deactivation of TCI states associated to the reported predicted DL RS. RSRP is used as an example of measurement quantity or quality, but other quantities may also be used, such as signal to interference plus noise ratio (SINR), reference signal received quality (RSRQ), received signal strength indicator (RSSI), etc.;
DL RS in the Set A in which the predicted measurement has the weakest RSRP; In other words, at a given time instance (e.g., t0) after the WD 22 performed the measurements on the Set B, the WD 22 predicts RSRP values (e.g., SS-RSRP, L1 RSRP) of one or more DL RSs of set A based on these measurements. The predictions are predictions of the values these DL RSs of set A would have after a time period and after some measurement occasions. Then, the WD 22 selects the DL RS (and/or beam associated) with the weakest predicted RSRP value. When reported to the network, the weakest predicted value indicates to the network what is a not good candidate beam (DL RS) at a future time instance. Based on this indication, the network node 16 may perform reconfiguration of beam related parameters for removal of certain candidates and/or activation/deactivation of beam related configuration. For example, This may include activation/deactivation of CSI measurement resource(s) and/or activation/deactivation of TCI states associated to the reported predicted DL RS.

In some embodiments, the DL RS configuration is for one or more types of RSs transmitted by the network node 16, which may be transmitted on one or more beams, These beams may correspond to one or more CSI-RS resources (including TRS (CSI-RS for tracking)), SSBs, CRSs, DMRSs, PTRSs (phase-tracking RS) and/or DRSs.

In some embodiments, the DL RS configuration corresponds to a resource configuration used for indicating to the WD 22 which DL RS resources are to be measured for the purpose of CSI reporting. In some embodiments, these resources (i.e., DL RSs transmitted by the network) are also to be used by the WD 22 for performing measurements to be used the WD 22 to perform the one or more time-domain prediction(s) of the set A of DL RSs/beams.

In some embodiments, the WD 22 performs the one or more time-domain predictions of one of more CSI measurements on a second set of one or more DL RS(s) (Set A) based on a Machine Learning (ML)-model deployed (installed or placed) at the WD 22. The term “ML-model” or “AI-model”, “Model Inference”, “Model Inference function” or “AI/ML model” are used interchangeably. An AI/ML model may be defined as a functionality or be part of a functionality that is deployed/implemented in a first node (e.g., a WD 22). An AI/ML model may be defined as a feature or part of a feature that is implemented or supported in a first node e.g., a WD 22. An ML-model (or Model Inference function) may correspond to a function which receives one or more inputs (e.g., measurements from the Set B) and provides as an outcome one or more prediction(s), estimates and decisions of a certain type, e.g., for the set A. It may be said that an ML model or Model Inference is a function that provides AI/ML model inference output (e.g., predictions or decisions). The Model inference function is also responsible for data preparation (e.g., data pre-processing and cleaning, formatting, and transformation) based on Inference Data delivered by a Data Collection function, if required. The output may correspond to the inference output of the AI/ML model produced by a Model Inference function. In the present context, the predictions are time-domain predictions: thus, the input of the ML-model is one or more measurements at (or starting at) a time instance t0 (and/or a timer interval such as T1 or t0+T1, which may include one or more samples or measurement time occasions, from 1 to K time occasions). The output of the ML-model may include one or more predicted measurements at (or starting at) a future time instance, e.g., t0+T, possibly including future time instances within a time window of duration T2 and having F predictions.

The term “Actor”, refers to a function that receives the output from the Model inference function and triggers or performs corresponding actions. The Actor may trigger actions directed to other entities or to itself. In the present context, one actor may correspond to CSI/beam prediction reporting (or CSI prediction reporting) functionality at the WD 22, and/or the functionality at the WD 22 responsible for generating the data structure to transmit the one or more information derived based on the one or more time-domain predictions. In some embodiments, an ML-model may correspond to a function receiving as input one or more measurements of at least one DL RS at time instance t0 (or a time interval starting or ending at t0), after at least one measurement period, (e.g., transmitted in beam-X, SSB-x, CSI-RS resource index x) and provide as output, the prediction of the RS measurement(s) in time instance t0+T (or a time interval starting or ending at t0+T, until t0+T+T2). This future time instance t0+T, obtained at t0, may be in different time units such as in number of slots (frames, sub-frames, OFDM symbols, etc.) after the WD 22 has performed the last measurement or targeting a specific slot in time within the future.

In some embodiments, the WD 22 performs at least one measurement on a first set of DL RSs (Set B), based on the DL RS configuration, where the at least one measurement corresponds to measurement of one or more measurement quantities, e.g., RSRP and/or RSRQ, and/or received signal strength indicator (RSSI), and/or SINR, measured on one or more DL RS(s). These downlink reference signals may include SSB, CSI-RS, Cell-specific Reference Signal (CRS), Discovery Reference Signal (DRS), and/or Demodulation Reference Signal (DMRS). The one or more measured RS(s) may be transmitted in different spatial direction(s), which may be referred as different beams. For example, a measurement on a beam may correspond to an SS-RSRP (Synchronization Signal Reference Signal Received Power) on an SSB index X of a cell Y, wherein the SSB of SSB index X is transmitted in a beam/spatial direction. More examples of measurements may be found in 3GPP TS 38.215, such a SS-RSRQ, SS-SINR, CSI-RSRP, CSI-RSRQ, CSI-SINR. Measurements on one or more beams may be obtained during a measurement period, as defined in 3GPP TS 38.133. Thus, a measurement at time t0 (or time interval t0+T1), may refer to a measurement period which has ended at time t0+T1, e.g., the end of a time window, moving average of measurement samples, etc.

In some embodiments, at t0 (and/or at a time interval t0+T1), a time-domain prediction (or estimate) of a CSI measurement may correspond to at least one value (e.g., generated as the output of an ML-model) which represents an estimate of the measurement for a future point in time e.g., t0+T+T2. At t0, there may be multiple predictions or estimates of the measurement (e.g., for t0+1*T, t0+2*T, t0+3*T, . . . , t0+F*T, where T is the prediction/estimation periodicity, and F is the number of time-domain predictions or estimates). The value T2, including F the predictions, may represent the prediction interval, in time units, or prediction window. These parameters i) may be received by the WD 22, in a message from the network, as a configuration for the WD 22 to perform the predictions, and/or ii) they may be obtained in the WD's memory if hard-coded (e.g., if they are specified), and/or iii) they may be obtained based on one or more rules depending on radio related parameters such as the WD's currently used subcarrier spacing, carrier frequency, frequency range, use or non-use of discontinuous reception DRX, etc.

In some embodiments, a time-domain prediction or estimate of the CSI measurement is performed at t0+1*T, t0+2*T, t0+3*T, . . . , t0+F*T, where T is one or more of: i) a measurement period (e.g., as defined in 3GPP TS 38.133; or ii) a value derived from a measurement period (e.g., a multiple, or a fraction of the measurement period). That value may vary according to one or more properties of the RS for which the prediction needs to be derived, e.g. SSB measurement timing configuration (SMTC) periodicity, subcarrier spacing, etc. That value may vary according to other properties such as if the WD 22 is in discontinuous reception (DRX) or not, if the WD 22 is configured to perform other predictions and/or measurements, etc.

In some embodiments, the WD 22 is configured by the network with one or more parameters indicating how in the time-domain the predictions are to be performed, such as the prediction/estimation periodicity (T), the number of measurement time occasions (K), and the number of predictions (F), the prediction window (T2), or any of the other parameters described herein. In some embodiments, the WD 22 is configured with the value T2 and/or F*T representing the total prediction interval, in time units. In some embodiments, one or more parameters are obtained by the WD 22 in its memory (e.g., in case the parameters may be standardized and hard coded at the WD 22).

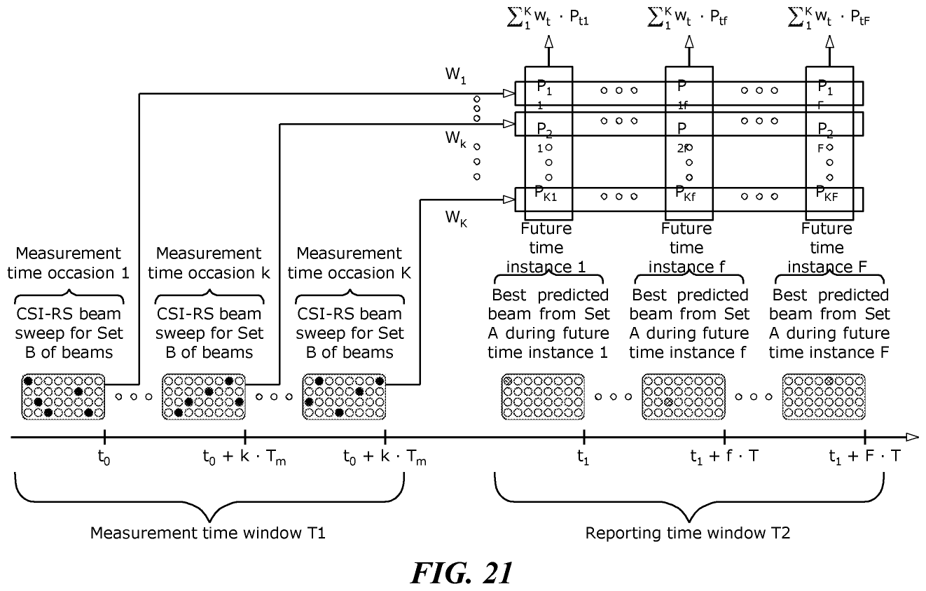

In some embodiments, the value of F may be updated for every measurement time occasion if the measurement configuration is updated. Otherwise, the value of F will be fixed within the measurement time window T1. If the WD 22 is configured to perform the F predictions or estimates of the measurement for every measurement time occasion. For the k-th measurement time occasion (time stamp t0+T_m*(k−1)), WD 22 will perform the F predictions or estimates of the measurement at future time stamps t1+1*T, t1+2*T, t0+t1+3*T, . . . , t1+F*T, where t1=t0+T1+Tp, t1 may be regarded as the common starting point of the prediction time window, and Tp is the mandatory processing delay. For simplicity, the periodicity of measurement time occasions (T_m) may be set to be the same as the prediction/estimation periodicity (T), i.e., T_m=T. The value of T_m and T may be different depending on the radio related parameters. Such radio related parameters may include the WD's currently used subcarrier spacing, carrier frequency, frequency range, usage of DRX or not, etc. A general example may be found in FIG. 21.

For a given K, the value of F may be different or the same for every measurement time occasion. For example, by assuming K=3 and Pᵢⱼ, which is defined as the predictions or estimates of the measurement at future time stamps (t1+j*T for j=1, 2, . . . , F) based on the i-th measurement time occasion, the following options may exist:
Option I: the value of F is fixed, e.g., F=4 for each measurement time occasion:
At the 1^{st} measurement time occasion (k=1 at time stamp t0), WD 22 will perform F=4 predictions or estimates of the measurement at future time stamps and obtain P₁=[P₁, P₁₂, P₁₃, P₁₄];
At the 2^{nd} measurement time occasion (k=2 at time stamp t0+T), WD 22 will perform F=4 predictions or estimates of the measurement at future time stamps and obtain P₂=[P₂₁, P₂₂, P₂₃, P₂₄];
At the 3^{rd} measurement time occasion (k=3 at time stamp t0+2*T), WD 22 will perform F=4 predictions or estimates of the measurement at future time stamps and obtain P₃=[P₃₁, P₃₂, P₃₃, P₃₄];
   Option II: the value of F is different for each measurement time occasion:

One example is as follows:
At the 1^{st} measurement time occasion (k=1 at time stamp t0), WD 22 will perform F=4 predictions or estimates of the measurement at future time stamps and obtain P₁=[P₁, P₁₂, P₁₃, P₁₄];
At the 2^{nd} measurement time occasion (k=2 at time stamp t0+T), WD 22 will perform F=3 predictions or estimates of the measurement at future time stamps and obtain P₂=[P₂₁, P₂₂, P₂₃]; and
At the 3^{rd} measurement time occasion (k=3 at time stamp t0+2*T), WD 22 will perform F=5 predictions or estimates of the measurement at future time stamps and obtain P₃=[P₃₁, P₃₂, P₃₃, P₃₄, P₃₅].

For each option, the prediction may be combined depending on the reporting configuration. For example, the network node 16 may configure the weight for each measurement time occasion. For example, for the k-th measurement time occasion, the weight is set as wₖ. Then, the WD 22 may use this weight when combining the different predictions at the same prediction time stamp. The final prediction at the time stamp t1+f*T may be:

$${\sum }_{1}^{K} {w}_{i} * {P}_{if}$$

Note: the value of F may be selected as the minimum value of all configured F. For example, the value of F may be 4 and 3 for option I and option II, respectively.

In some embodiments, the future time instance t1=t0+T, obtained, e.g., at t0, may be in different time units. In some embodiments, the time units may be a number of measurement periods, slots (or frames, sub-frames, OFDM symbols, etc.) after the WD 22 has performed the last measurement or targeting a specific slot in time in the future. For example, at time t0, the WD 22 may generate at least one prediction for time instance t1=t0+T, which may be the estimate for the next measurement period.

For RSRP of an SSB, for example, the one or more time-domain predictions may correspond to a time series of predictions at time t0, leading to [RSRP(t1=t0+T), RSRP(t1+T′), RSRP(t1+2*T′), . . . , RSRP(t1+(F−1))T′)] as an outcome.

For example, the SS-RSRP prediction/estimate at t0, for a time future at time t1=t0+T, may correspond to the estimate in t0+T of the linear average over the power contributions (in [W]) of the resource elements that carry secondary synchronization signals (SSSs), which the SSB would have at time t0+T. For predicting SS-RSRP, demodulation reference signals for the physical broadcast channel (PBCH) at time t0 or estimates for t0+T may be used. In some embodiments, the prediction/estimate at t0 may be performed for SS-RSRQ, SS-SINR, CSI-RSRP, CSI-RSRQ, CSI-SINR.

In some embodiments, for the RSRP of an SSB, the one or more predictions may correspond to a time series of predictions at time t0 defined by an autoregressive (AR) model. An autoregressive model may include a time-series value being regressed (predicted, estimated or inferred) on previous values from that same time series. For example, an AR-model with two components is illustrated below.

$${y}_{{t}_{o} + 1} = {β}_{0} + {β}_{1} {y}_{{t}_{0}} + {β}_{2} {y}_{{t}_{0} - 1} + {ϵ}_{{t}_{0}}$$

In some embodiments, the estimate of the SS-RSRP (or prediction for t0+T) is estimated or predicted among the reference signals corresponding to SS/PBCH blocks (SSB) with the same SS/PBCH block index and the same physical-layer cell identity.

Note that an SSB is an acronym for SS/PBCH block or Synchronization Sequence Block (SSB).

### Predicted Information Based on the One or More Time-Domain Prediction(s) on Set A

NOTE: RSRP (e.g., SS-RSRP, CSI-RSRP) is usually used as an example of measurement quantity or CSI measurement to be performed and/or predicted, but other measurement quantities may also be equally considered such as RSRQ, SINR, RSSI. Similarly, SSB is usually use as an example of DL RS which is beamformed, but other RSs may also be equally considered such as CSI-RS, DRMS, CRS, DRS, etc.

In some embodiments, the predicted information which is transmitted to the network (e.g., in a CSI report) may include at least one of the time-domain prediction(s) of CSI measurements. For example, for a given beam (SSB-X, whose SSB index=X) the WD 22 transmits the predicted RSRP for SSB-X e.g., predicted SS-RSRP′(t1=t0+T), SS-RSRP′(t1+T′), . . . , SS-RSRP′(t1+(F−1)*T′).

In some embodiments, the predicted information may include an average (e.g., moving average, filtered averaged, weighted average) based on at least one time domain prediction(s) of CSI measurements. For example, for a given beam (SSB-X, whose SSB index=X), the WD 22 transmits an average of the predicted RSRP for SSB-X e.g., for predicted SS-RSRP′(t0+T), SS-RSRP′(t0+2*T), . . . , SS-RSRP′(t0+K*T), the WD 22 may indicate an average of these values. That may also include an indication of the RS index/identifier.

In some embodiments, the predicted information may include a statistical metric derived based on the distribution of the multiple time domain prediction(s) of CSI measurements, as indicated in herein. For example, for a given beam (SSB-X, whose SSB index=X) the WD 22 transmits a statistical metric of the predicted RSRP(s) for SSB-X e.g., predicted SS-RSRP′(t1), SS-RSRP′(t1+T′), . . . , SS-RSRP′(t1+(F−1)*T′). That may also include an indication of the RS index/identifier. The statistics may be generated using ML-model/s/methods such as ensemble-based procedures, which include a number of so-called weak learners, each providing a prediction of an SS-RSRP in a certain time-instance. The statistical metric may include, for each time instance, the average value and standard deviation of such value. Or for example, the confidence interval of the expected value, e.g., 90% probability that the value is within a certain range. In some embodiments, the statistics of a predicted value may be reported as the below probability density function, using e.g., Gaussian mixtures for each of the t1, t1+T′, t1+2T′, . . . t1+(F−1)T′. The prediction may then be reported using the parameters describing the mixed gaussian components. Its mean, variation and component weight for each of the components.

In some embodiments, the predicted information may include at least one metric (value, parameter, indication) which is derived (generated) by the WD 22 based on one or more time domain prediction(s) of measurements.

In some embodiments, the one or more indications may include a beam identifier, derived (generated) by the WD 22 based on one or more time domain prediction(s) of measurements. A beam identifier may correspond to a RS ID e.g., an SSB index, CSI-RS resource identifier.

In some embodiments, the predicted information based on time domain prediction(s) of CSI measurements of Set A may include an indication of the RS index/identifier (e.g., SSB identifier). In some embodiments, the indication of the RS index/identifier corresponds to the actual RS index/identifier e.g., an SSB is indicated by its explicit SSB identifier (X, for SSB index=X). In some embodiments, the indication of the RS index/identifier corresponds to a configuration identifier, based on a mapping provided in the RRC configuration: for example, the WD 22 may be configured with a list of SSB indices, e.g., LIST=[SSB index-5, SSB index-12, SSB index-60], so that what is reported is the position in the list. For example, if the WD 22 sends the prediction for SSB index-12, it indicates the prediction is for the SSB in position 1. If the WD 22 sends the prediction for SSB index-5, it indicates the prediction is for the SSB in position 0, and if the WD 22 sends the prediction for SSB index-60, it indicates the prediction is for the SSB in position 2. This allows fewer bits to be included in the first MAC CE.

In some embodiments, the WD 22 derives the predicted information based at least in part on a threshold associated to a measurement quantity (e.g., RSRP, RSRQ, SINR, RSSI) which is to be predicted or estimated. For example, if RSRP is the measurement quantity, the WD 22 predicts the RSRP of at least one SSB in the time-domain (SS-RSRP), for time instances t1, t1+T′, . . . , t1+T′(F−1), then the WD 22 derives the predicted information to be reported by comparing the predictions/estimates with an RSRP threshold (which may be part of the reporting configuration).

In some embodiments, the predicted information may include an indication of a ratio of predictions above the threshold to the total number of predictions (F) in a given prediction interval (T2=F*T′).

In some embodiments, the WD 22 derives the predicted information to be reported, based on at least a counter value associated to a measurement quantity that is to be predicted or estimated. For example, if the WD 22 predicts the RSRP of at least one SSB in the time-domain, in time instances t1, t1+T′, . . . , t1+(F−1)T′, the WD 22 derives the predicted information by comparing the number of predictions/estimates above an RSRP threshold, with the counter value.

### Reporting the Predicted Information

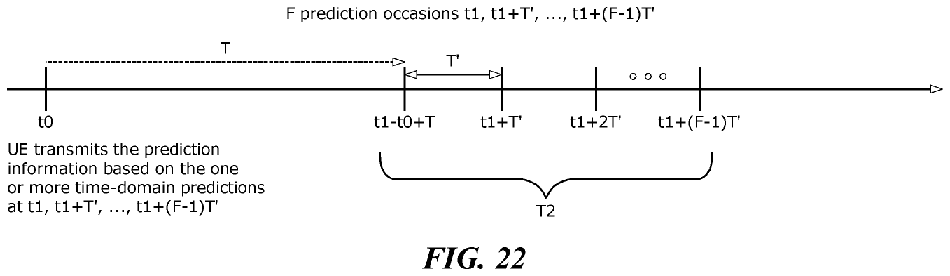

A method at the WD 22 may further include the WD 22 including the predicted information in a CSI report, including at least one CSI measurement for a beam (or/and DL RS transmitted in a spatial direction and/or transmitted according to a spatial filter) and the predicted information.
For example, the WD 22 may be configured with a reporting configuration (e.g., CSI-ReportConfig), and based on that configuration, the WD 22 may include in a CSI report a CSI measurement of one DL RS performed at a time t0 (or time interval t0+T1), such as an SS-RSRP value and/or L1 RSRP for SSB index X. In addition, the WD 22 may also include in the CSI report at least one prediction information based on one or more time-domain predictions of the same CSI measurement (SS-RSRP and/or L1 RSRP for SSB index X) being reported, such as a predicted RSRP value (or information derived from it) of SSB index X. The trigger for the WD 22 to report may also be included in the reporting configuration, e.g., the reception of a trigger command via MAC CE and/or DCI (or a periodicity for the CSI reports).
The prediction information may be F differential RSRP values (having the actual measurement as their reference) for the F time domain predictions of SS-RSRP of beam X, each value being for a future time instance. In that case, the value F is provided to the WD 22 in the reporting configuration (e.g., CSI reporting configuration) so it is known to both the WD 22 and the network node 16. Hence, when the WD 22 performs a CSI measurement for SSB index X at t0, it predicts the CSI measurement for SSB index X at t1=t0+T, t1+T′, t1+T′*2, . . . , t1+T′*f, . . . , t1+T′*(F−1), wherein T2=(F−1)*T′, and may include in the CSI report the SS-RSRP for beam X, and the differential values of the predicted SS-RSRP for beam X in time instances t1=t0+T, t1+T′, t1+T′*2, . . . , t1+T′*f, . . . , t1+T′*(F−1). See FIG. 22

In some embodiments, a method at the WD 22 may further include including the predicted information in a predicted CSI report, triggered according to the reporting configuration (and not including CSI measurements).
For example, the WD 22 may be configured with a reporting configuration (e.g., CSI-PredictedReportConfig), and based on that configuration, the WD 22 may transmit a predicted CSI report at time t0 (possibly based on measurements on or time interval t0-T1). The report may include prediction information based on one or more time-domain predictions of a CSI measurement (SS-RSRP and/or L1 RSRP for SSB index X), such as one predicted RSRP value (or information derived from it) of SSB index X at a future time instance t1=t0+T and one or more differential SS-RSRP values for the same SSB index X for future time instances t1+T′, t1+T′*2, . . . , t1+T′*f, . . . , t1+T′*(F−1).
The prediction information may be the F−1 differential RSRP values (having the first predicted SS-RSRP as their reference) of beam X, each value being for a future time instance. In that case, the value F may be provided to the WD 22 in the reporting configuration (e.g., CSI predicted reporting configuration), so that it is known to both the WD 22 and the network node 16. Hence, when the WD 22 reports the predicted CSI measurement for SSB index X at t0, it predicts the CSI measurement for SSB index X at t1=t0+T, t1+T′, t1+T′*2, . . . , t1+T′*f, . . . , t1+T′*(F−1), wherein T2=(F−1)*T′, and may include in the CSI predicted report the first predicted SS-RSRP for beam X for t1=t0+T, and the differential values of the predicted SS-RSRP for beam X in time instances t1+T′, t1+T′*2, . . . , t1+T′*f, . . . , t1+T′*(F−1).
The prediction information may additionally include the F−1 uncertainty values associated to each RSRP value. For example, the confidence interval of each prediction may be represented by the standard deviation of the prediction, or by a value range within which the predicted RSRP is within a certain probability. For example, the WD 22 may determine that there is a 95 percent probability that the SINR predictions are within [8 dB,10 dB]. The range may also be reported as a sequence of differentials.

In some embodiments, a method at the WD 22, may include performing one or more time-domain predictions of one of more CSI measurements on a set of one or more DL RS(s) (Set A), based on at least one measurement on a first set of DL RSs (Set B).

In some embodiments, the set of one or more DL RS(s) (Set A), i.e., the DL RSs for which the WD 22 performs the one or more time-domain predictions of one of more CSI measurements, may be transmitted by the network node 16 in different spatial directions and/or with different spatial domain filters. Thus, these DL RSs correspond to a set of beams A, or simply Set A of beams, or set A. Thus, the WD 22 may predict and report future network node beams. Similarly, the DL RSs which are measured (Set B) may be transmitted by the network node 16 in different spatial directions and/or with different spatial domain filters. Thus, these DL RSs correspond to a set of beams B, or simply Set B of beams, or set B.

### Selecting DL RS (Beam, SSB, CSI-RS Resource) for the CSI Report

In some embodiments, the reporting configuration is associated to a resource configuration and/or a resource set configuration indicating to the WD 22 one or more DL RS indices (e.g., SSB indices and/or CSI-RS resource identifier, which may be considered as beam identifiers) in which the WD 22 may perform the one or more time-domain predictions (set A). Based on this, the WD 22 derives the predicted information which is included in a CSI report transmitted to the network.

Reporting single DL RS: In some embodiments, the WD 22 selects one DL RS out of the set A to include in the CSI report based on one or more CSI measurements of the DL RSs in set A, and also may include the predicted information for the same selected DL RS. For example, the CSI reporting configuration (CSI-ReportConfig) may be associated to SSB index(1), SSB index(7) and SSB index(13) for set A, meaning that these are SSBs for which the WD 22 performs the one or more CSI measurement(s) and one or more time-domain predictions of CSI measurement(s) e.g., predicted SS-RSRP and/or L1-RSRP value(s). The WD 22 may transmit the CSI report at time t0 (e.g., based on a trigger from the network, or if t0 is the slot/time occasion configured for transmitting the report, in case of periodic report). For that CSI report instance, the WD 22 selects the SSB in the configured resource set for which the SS-RSRP (or L1 RSRP) is to be included in the CSI report as the SSB whose SS-RSRP at t0 is the strongest SS-RSRP e.g., SSB index (7). For the selected SSB, the WD 22 may include the CSI measurement (e.g., SS-RSRP) and the predicted information, also for SSB index 7. In other words, it is based on the CSI measurement that the WD 22 selects the SSB to include in that CSI report instance, and, based on that it also may include the predicted information for the same SSB.

Group reporting: In some embodiments, the WD 22 receives in the reporting configuration one indication that the CSI report is to include information about a group of beams (e.g., group of DL RSs within the set of A), i.e., the WD 22 may include information in the CSI report for more than one beam (i.e., for more than one SSB index). The WD 22 selects a group of “M” DL RSs (e.g., M beams and/or M SSB indices and/or M CSI-RS resource identifiers and/or M DL RS identities) out of the set A to include in the CSI report based on one or more CSI measurements of the DL RSs in set A, and also may include the predicted information for the same selected DL RS. For example, the CSI reporting configuration (CSI-ReportConfig) may be associated to SSB index(1), SSB index(7) and SSB index(13) for set A, meaning that these are SSBs for which the WD 22 performs the one or more CSI measurement(s) and one or more time-domain predictions of CSI measurement(s) e.g., predicted SS-RSRP and/or L1-RSRP value(s). The WD 22 may transmit the CSI report at time t0 (e.g., based on a trigger from the network, or if t0 is the slot/time occasion configured for transmitting the report, in case of periodic report). For that CSI report instance, the WD 22 selects the “M” SSBs (associated to M SSB indices) in the configured resource set for which the SS-RSRP (or L1 RSRP) is to be included in the CSI report as the “M” SSBs whose SS-RSRP values at t0 are the “M” strongest SS-RSRP(s), e.g., SSB index (7) and SSB index (1) for M=2, wherein M is configured. For the selected SSBs, the WD 22 may include the CSI measurement (e.g., SS-RSRP) and the predicted information, i.e., for SSB index 7 and SSB index 1. In other words, it is based on the CSI measurement that the WD 22 selects the “M” SSBs to include in that CSI report instance. Based on the selection, the WD 22 may include the predicted information for the same SSBs.

In some embodiments, the WD 22 may select one DL RS out of the set A to include in the CSI report based on a combination of one or more CSI measurements of the DL RSs in set A and one or more time-domain predictions, and also may include the predicted information for the same selected DL RS. For example, the CSI reporting configuration (CSI-ReportConfig) may be associated to SSB index(1), SSB index(7) and SSB index(13), meaning these are SSBs for which the WD 22 performs the one or more CSI measurement(s) and one or more time-domain predictions of CSI measurement(s) e.g., predicted SS-RSRP and/or L1-RSRP value(s).
In one option, the WD 22 may transmit the CSI report at time t0 (e.g., based on a trigger from the network, or if t0 is the slot/time occasion configured for transmitting the report, in case of periodic report). For that CSI report instance, the WD 22 may select the SSB in the configured resource set for which the SS-RSRP (or L1 RSRP) is to be included in the CSI report as the SSB whose the average of the SS-RSRP at t0 and one or more time-domain predictions of the SS-RSRP is the strongest SS-RSRP e.g., SSB index (13). For the selected SSB, the WD 22 may include the CSI measurement (e.g., SS-RSRP) and the predicted information, also for SSB index 13.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select the SSB in the configured resource set for which the SS-RSRP (or L1 RSRP) is to be included in the CSI report as the SSB whose weighted average of the SS-RSRP at t0 (with higher weighting factor) and one or more time-domain predictions of the SS-RSRP (with lower weighting factor in descending order if more than one time-domain predictions) is the strongest SS-RSRP e.g., SSB index (13). For the selected SSB, the WD 22 may include the CSI measurement (e.g., SS-RSRP) and the predicted information, also for SSB index 13.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select the SSB in the configured resource set for which the SS-RSRP (or L1 RSRP) is to be included in the CSI report as the SSB whose the SS-RSRP at t0 and one or more time-domain predictions of the SS-RSRP is the strongest SS-RSRP e.g., SSB index (13). For the selected SSB, the WD 22 may include the CSI measurement (e.g., SS-RSRP) and the predicted information, also for SSB index 13.
In other words, it is based on the combination between CSI measurement and time-domain predictions of the CSI measurement that the WD 22 selects the SSB to include in that CSI report instance. Based on the selection, the WD 22 also may include the predicted information for the same SSB.

Group reporting: In some embodiments, the WD 22 may select a group of “M” DL RSs (e.g., M beams, M DL RS indices, M SSB indices) out of the set A to include in the CSI report based on a combination of one or more CSI measurements of the DL RSs in set A and one or more time-domain predictions, and also may include the predicted information for the same selected DL RSs. For example, the CSI reporting configuration (CSI-ReportConfig) may be associated to SSB index(1), SSB index(7) and SSB index(13), meaning these are SSBs for which the WD 22 performs the one or more CSI measurement(s) and one or more time-domain predictions of CSI measurement(s) e.g., predicted SS-RSRP and/or L1-RSRP value(s).
In one option, the WD 22 may transmit the CSI report at time t0 (e.g., based on a trigger from the network, or if t0 is the slot/time occasion configured for transmitting the report, in case of periodic report). For the CSI report instance, the WD 22 may select a group of “M” SSBs in the configured resource set for which the SS-RSRPs (or L1 RSRP) are to be included in the CSI report as the SSBs whose the average of the SS-RSRP at t0 and one or more time-domain predictions of the SS-RSRP are the strongest SS-RSRP e.g., SSB index (13) and SSB index (7). For the “M” selected SSBs, the WD 22 may include the CSI measurement (e.g., SS-RSRP) and the predicted information, i.e., for SSB index 13 and SSB index 7.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select a group of “M” SSBs in the configured resource set for which the SS-RSRPs (or L1 RSRP) are to be included in the CSI report as the SSBs whose the weighted average of the SS-RSRP at t0 (with higher weighting factor) and one or more time-domain predictions of the SS-RSRP (with lower weighting factor in descending order if more than one time-domain predictions) are the strongest SS-RSRP e.g., SSB index (13) and SSB index (7). For the “M” selected SSBs, the WD 22 may include the CSI measurement (e.g., SS-RSRP) and the predicted information, i.e., for SSB index 13 and SSB index 7.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select a group of “M” SSBs in the configured resource set for which the SS-RSRPs (or L1 RSRP) are to be included in the CSI report as the SSB whose the SS-RSRP at t0 and one or more time-domain predictions of the SS-RSRP are the strongest SS-RSRP e.g., SSB index (13) and SSB index (7). For the selected SSBs, the WD 22 may include the CSI measurement (e.g., SS-RSRP) and the predicted information, i.e., for SSB index 13 and SSB 7.
In other words, it is based on the combination between CSI measurement and time-domain predictions of that CSI measurement that the WD 22 selects the group of “M” SSBs to include in that CSI report instance. Based on the selection, the WD 22 may also include the predicted information for the same SSBs.

In some embodiments, the WD 22 may select one DL RS out of the set A to include in the CSI report based on one or more time-domain predictions of the CSI measurements of the DL RSs in set A and may include the actual CSI measurement and the predicted information for the same selected DL RS. For example, the CSI reporting configuration (CSI-ReportConfig) may be associated to SSB index(1), SSB index(7) and SSB index(13), meaning these are SSBs for which the WD 22 performs the one or more CSI measurement(s) and one or more time-domain predictions of CSI measurement(s) e.g., predicted SS-RSRP and/or L1-RSRP value(s).
In one option, the WD 22 may transmit the CSI report at time t0 (e.g., based on a trigger from the network, or if t0 is the slot/time occasion configured for transmitting the report, in case of periodic report). For that CSI report instance, the WD 22 may select the SSB in the configured resource set for which the SS-RSRP (or L1 RSRP) is to be included in the CSI report as the SSB whose the average of the one or more time-domain predictions of the SS-RSRP is the strongest SS-RSRP, e.g., SSB index (1). For the selected SSB, the WD 22 may include the CSI measurement (e.g., SS-RSRP) and the predicted information, also for SSB index 1.
In one option, the WD 22 may transmit the CSI report at time t0 (e.g., based on a trigger from the network, or if t0 is the slot/time occasion configured for transmitting the report, in case of periodic report). For that CSI report instance. the WD 22 may select the SSB in the configured resource set for which the SS-RSRP (or L1 RSRP) is to be included in the CSI report as the SSB whose the weighted average of the one or more time-domain predictions of the SS-RSRP (weighting factor in descending order if more than one time-domain predictions) is the strongest SS-RSRP e.g., SSB index (1). For the selected SSB, the WD 22 may include the CSI measurement (e.g., SS-RSRP) and the predicted information, also for SSB index 1.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select the SSB in the configured resource set for which the SS-RSRP (or L1 RSRP) is to be included in the CSI report as the SSB whose the one or more time-domain predictions of the SS-RSRP is the strongest SS-RSRP e.g., SSB index (1). For the selected SSB, the WD 22 may include the CSI measurement (e.g., SS-RSRP) and the predicted information, also for SSB index 1.
In other words, it is based on the one or more time-domain predictions of that CSI measurement that the WD 22 selects the SSB to include in that CSI report instance. Based on the selection, the WD 22 may also include the predicted information for the same SSB.
(group reporting) In some embodiments, the WD 22 may select “M” DL RS out of the set A to include in the CSI report based on one or more time-domain predictions of the CSI measurements of the DL RSs in set A and may include the actual CSI measurement and the predicted information for the same selected DL RSs. For example, the CSI reporting configuration (CSI-ReportConfig) may be associated to SSB index(1), SSB index(7) and SSB index(13), meaning these are SSBs for which the WD 22 performs the one or more CSI measurement(s) and one or more time-domain predictions of CSI measurement(s) e.g., predicted SS-RSRP and/or L1-RSRP value(s).
In one option, the WD 22 may transmit the CSI report at time t0 (e.g., based on a trigger from the network, or if t0 is the slot/time occasion configured for transmitting the report, in case of periodic report). For that CSI report instance, the WD 22 may select a group of M SSBs in the configured resource set for which the SS-RSRPs (or L1 RSRPs) are to be included in the CSI report as the SSBs whose the averages of the one or more time-domain predictions of the SS-RSRPs are the strongest SS-RSRPs e.g., SSB index (1) and SSB index (7). For the M selected SSBs, the WD 22 may include the CSI measurement (e.g., SS-RSRP) and the predicted information, i.e., for SSB index 1 and SSB index 7.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select a group of M SSBs in the configured resource set for which the SS-RSRPs (or L1 RSRPs) are to be included in the CSI report as the SSBs whose the weighted averages of the one or more time-domain predictions of the SS-RSRPs (weighting factor in descending order if more than one time-domain predictions) are the strongest SS-RSRPs e.g., SSB index (1) and SSB index (7). For the M selected SSBs, the WD 22 may include the CSI measurement (e.g., SS-RSRP) and the predicted information, i.e., for SSB index 1 and SSB index 7.
In one option, the WD 22 may transmit the CSI report at time t0 (e.g., based on a trigger from the network, or if t0 is the slot/time occasion configured for transmitting the report, in case of periodic report). For that CSI report instance, the WD 22 may select a group of M SSBs in the configured resource set for which the SS-RSRPs (or L1 RSRPs) are to be included in the CSI report as the M SSBs whose the one or more time-domain predictions of the SS-RSRPs are the strongest SS-RSRPs e.g., SSB index (1) and SSB index (7). For the M selected SSBs, the WD 22 may include the CSI measurement (e.g., SS-RSRP) and the predicted information, i.e., for SSB index 1 and SSB index 7.
In other words, it is based on the one or more time-domain predictions of that CSI measurement that the WD 22 selects the M SSBs to include in that CSI report instance, and, based on that it also may include the predicted information for the same SSB.

In some embodiments, the WD 22 may include in the CSI report an indication of at least one DL RS identifier, associated to the CSI measurement and the at least one predicted information based on the time-domain prediction of a CSI measurement).
The indication of a DL RS identifier may correspond to one or more of:
   the SSB index of the selected SSB;
   the CSI-RS resource identifier of the selected CSI-RS resource;
   the beam identifier of the selected beam;
The indication of a DL RS identifier may correspond to one or more of:
   The position (e.g., in the list) of the selected SSB index in the resource configuration associated to that CSI report. If the resource configuration (or resource set) associated to that CSI report may include a list of SSBs (e.g., SSB index 1, SSB index 3 and SSB index 7) and the WD 22 selects SSB index 3 to be reported, the WD 22 may include in the CSI report, as the indication of the DL RS, the position in which SSB index 3 has been configured, which in this example is the position 1 (in an order of 0, 1, 2 for a number of 3 elements).
   The position (e.g., in the list) of the selected CSI-RS resource identifier in the resource configuration associated to that CSI report. If the resource configuration (or resource set) associated to that CSI report may include a list of CSI-RS resources (e.g., CSI-RS resource 1, CSI-RS resource 3, CSI-RS resource 7) and the WD 22 selects CSI-RS resource index 1 to be reported, the WD 22 may include in the CSI report, as the indication of the DL RS, the position in which CSI-RS resource 1 has been configured, which in this example is the position 0 (in an order of 0, 1, 2 for a number of 3 elements).
   The position (e.g., in the list) of the selected beam resource identifier in the resource configuration associated to that CSI report (or beam report). If the resource configuration (or resource set) associated to that CSI report may include a list of beam identifier (e.g., beam ID 1, beam ID 3, beam ID 7) and the WD 22 selects beam ID 7 to be reported, the WD 22 may include in the CSI report (beam report), as the indication of the DL RS, the position in which beam ID 7 has been configured, which in this example is the position 2 (in an order of 0, 1, 2 for a number of 3 elements).

Some Embodiments may include one or more of the following:

1. A method in a User Equipment (UE), also called a wireless device, for reporting predicted network node beams from a set A of beams based on measurements of a set B of beams, the method comprising:
a. Receiving a report configuration (e.g., CSI reporting configuration or CSI prediction report configuration);
b. Report best predicted beams from set A of beams per indicated or determined future time instance (F) according to the report configuration.
   2. 1 and where the length of each future time instance (F) is the same and they are distributed sequentially in time (with or without a small gap period in between, where a gap period might be inserted to allow the WD to perform potential panel switching associated with the TCI state switch).
   3. 1 and where the “future time instances” F correspond to the time instances in which the WD is configured to report the predicted CSI e.g., in case the WD is configured with a periodic predicted CSI reporting. Hence, if the WD is configured to report predictions at every Xms, the WD perform the predictions at least at every Xms (e.g., before the WD needs to report).
   4. 1 and where the WD reports an instantaneous (lg) beam report (i.e., best beams that is not predicted for a future time instance) along the beam report with one or more predicted beams.
   5. 1 and where the WD determines and reports the future time instances (F) by indicating one or more of; A starting time of one or more future time instances; Duration of one or more future time instances; The end time of one or more future time instances.
   6. Indicating to the network a “DL TX beam prediction capability.”

Some embodiments may include one or more of the following:

1. A method in a User Equipment (UE), also called a wireless device, for predicting future network node beams (set A of beams) based on measurement of a set B of beams, the method comprising one or more of the following actions:
a. Perform measurements on DL reference signals associated with a Set B of beams, where the measurements are performed on at least two different Measurements time occasions (K), within a certain time window T1;
b. Compute predicted CSI for the beams belonging to the Set A of beams for one or more Future time instances (F), wherein the Future time instances are located within a certain time window T2;
   2. 1 and where how the WD should perform the measurements are conveyed in a CSI measurement configuration (1c), and where the CSI measurement configuration indicates the number of measurement time occasions (K) the WD may use when computing the predicted beams at one or more future time instances. The number K indicates to the WD the number of time domain occasions the network is transmitting the set of beams B.
   3. 1 and where a maximum time window T1 is indicated to the WD, and if a smaller number of transmission of the Set B of beams (L) compared to the indicated number of transmission of the Set B of beams (K) occurs within the given time window T1, the WD uses the L transmission of Set B beams when computing the predicted beams at one or more future time instances (i.e., T1 is used as maximum time window for collecting measurements on the set B of beams).
   4. 1 and where the Measurement time occasion is defined as a time interval wherein the WD receives all the beams in the set B of beams one time per beam
   5. Indicating to the network a “DL TX beam prediction capability”.

1. A method in a WD 22 for predicting future network node beams (set A of beams) based on measurement of a set B of beams, the method comprising one or more of the following actions:
a. Indicating to the network a “DL TX beam prediction capability;”
b. Receiving a DL reference signal configuration;
c. Receiving a CSI measurement configuration associated with (e.g., including) the DL reference signal (RS) configuration;
d. Receiving a command (e.g., DCI and/or MAC CE) indicating to the WD 22 a triggering of measurements on DL reference signals associated with a Set B of beams, or/and indicating to the WD 22 that previously configured DL RSs according to the DL RS configuration are being transmitted by the network and/or that the WD 22 may perform one or more CSI measurements on the DL RSs, according to the DL RS configuration. The DL RS configuration may correspond to a resource configuration;
e. Perform measurements on DL reference signals associated with a Set B of beams, where the measurements are performed on at least two different Measurements time occasions (K), within a certain time window T1;
   i. In one example, the measurement time occasions are within the SMTC configuration;
f. Compute predicted CSI for the beams belonging to the Set A of beams for one or more Future time instances (F), wherein the future time instances are located within a certain time window T2 and are possibly indicated (e.g., as part of the measurement configuration the WD 22 receives). The predicted CSI in this context may be an estimated CSI value for a future time instance;
g. The set A or the set B may include a single beam. Hence, another way to describe the idea is the WD 22 being configured to perform one or more measurements on a first beam at a point in time t0 and, based on that, predict a one or more measurements of a second beam at one or more points in time in the future t0+T*f, f=1, . . . , F.
h. “Predicting future network node beam” includes performing one or more time-domain predictions of a set of one or more DL RSs, such as one or more SSB(s) and/or CSI-RS resources; and/or
i. A “time-domain prediction of a beam” includes the quality (or estimated quality) of beam performed at a time t0 for a future time occasion (t0+T*f), for example, the RSRP (and/or RSRQ and/or SINR) of one or more SSBs in a future time occasion, obtained without having measure the quality of that RSRP (and/or RSRQ and/or SINR) of one or more SSBs at t0+T*f.

2. Embodiment 1 and further where “DL TX beam prediction capability” (1a) includes one or more of:
a. Support of the feature to report beams in future time instances;
b. Maximum number of future time instances (F) to report predicted beams for;
c. Maximum length of time window T2;
d. Minimum length of time window T2;
e. Minimum time delay between last received DL-RS to perform measurement on for beam prediction, and the time for reporting the predicted beams to the network node 16;
f. Maximum number of Measurement time occasions (K) of DL reference signals from Set B of beams during a time window T1;
g. Minimum number of Measurement time occasions (K) of DL reference signals from Set B of beams during a time window T1;
h. Maximum length of time window T1;
i. Minimum length of time window T1;

3. Embodiments 1 and/or 2, and where the DL reference signal configuration (1b) includes one or more CSI-RS resources or resource sets used for measurements (i.e., for Set B of beams), indicated by one or more CSI-RS resource identifiers:
a. The resources or resource sets may be associated to a serving cell the WD 22 is configured with, so that one or more CSI-RS resources or resources may be associated to a serving cell index.

4. Embodiments 1 and/or 2, and where the DL reference signal configuration (1b) includes one or more SSB resource sets used for measurements (i.e., for Set B of beams):
a. The resources or resource sets may be associated to a serving cell the WD 22 is configured with, so that one or more SSB resources or resources may be associated to a serving cell index;
b. The DL reference signal(s) may correspond to different types, such as:
   i. one or more Synchronization Signal Block(s) (SSB)(s) transmitted in different spatial directions by the network (which may be called beams) and received by the WD 22;
   ii. one or more CSI-RSs transmitted in different spatial directions by the network (which may be called beams) and received by the WD 22;
      The DL refence signal configuration may include, for a given type, one or more reference signal(s) identifiers, such as one or more SSB indices (e.g., SSB index=8, SSB index=3) and/or one or more CSI-RS resource identities;
      The DL reference signal configuration refers to RSs transmitted in a first set of beams B, wherein the first set of beams B correspond to a first set of spatial directions, wherein each RS is associated to the identifier;
      The DL reference signal configurations is included in a Serving Cell Configuration (e.g., IE ServingCellConfig, for a serving cell like the Pcell, PSCell or an Scell), and may refer to a DL reference signal of one of the serving cells of the Cell Group in which the Serving Cell configuration is included:
      The CSI reporting configuration in the Serving Cell Configuration of the Pcell may include the DL reference signal configuration of a DL reference signal of the Pcell or an Scell of the same cell group (in this example, the Master Cell Group);
      The CSI reporting configuration in the Serving Cell Configuration of the PSCell (in case the WD 22 is in Multi-Radio Dual Connectivity) may include the DL reference signal configuration of a DL reference signal of the PSCell or an Scell of the same cell group (in this example, the Secondary Cell Group);
      Thus, the set of beams B in which are transmitted the DL reference signals that may be measured for performing the time-domain predictions may correspond to beams (spatial directions) of a serving cell in the same cell group in which the CSI reporting configuration is included. So, when the WD 22 the CSI reporting configuration is included in the configuration of a serving cell 1 (e.g., the Pcell) for performing the one or more predictions (for reporting them) in a set of beams A, the WD 22 reports the one or more predictions in an Uplink channel of the Pcell (e.g., physical uplink shared channel (PUSCH) and/or physical uplink control channel (PUCCH) of the Pcell). However, the predictions (i.e., the set of beams A) may be for beams in serving cell 1, or in another serving cell in the same cell group e.g., serving cell 2 (which is an Scell), so that in the CSI reporting configuration the WD 22 receives an indication of which cell the set of beams A corresponds to e.g., a serving cell index.

5. Any of the enumerated Embodiments above, and where the CSI measurement configuration (1c) indicates the DL-RS resource sets used for measurements (i.e., Set B of beams).

6. Embodiment 5, and where the CSI measurement configuration (1c) indicates a time window T1, based on which the WD 22 perform measurements on the Set B of beams. In some embodiments, that time window T1 overlaps with an STMC configuration.

7. Embodiment 6, and where the WD 22 performs measurements on at least one transmission of the Set B of beams during the indicated time window T1, and use these measurements for computing predicted channel state information (If).

8. Embodiment 5, and where the CSI measurement configuration (1c) indicates the number of measurement time occasions (K) the WD 22 may use when computing the predicted beams at one or more future time instances. The number K indicates to the WD 22 the number of time domain occasions the network is transmitting the set of beams B.

9. Embodiment 8, and where the WD 22 performs measurements on at least one of the K indicated transmission of the Set B of beams, and use the one or more measurements for computing predicted channel state information (If).

10. Embodiment 9, and where a maximum time window T1 is indicated to the WD 22, and if a smaller number of transmission of the Set B of beams (L) compared to the indicated number of transmission of the Set B of beams (K) occurs within the given time window T1, the WD 22 uses the L transmission of Set B beams when computing the predicted beams at one or more future time instances (i.e., T1 is used as maximum time window for collecting measurements on the set B of beams).

11. Any of the enumerated Embodiments above, and where the WD 22 assumes that the same network node antenna port(s) (i.e., the same beam of the Set B of beams) are used for the same DL-RS resource transmitted at each of the K measurement time occasions within a time window T1.

12. Any of the enumerated Embodiments above, and where the CSI measurement configuration includes one Report setting (i.e., CSI-ReportConfig as specified in 3GPP TS 38.311), and where the Report setting is associated with the DL reference signal configuration.

13. Any of Embodiments 1, 2, 3, 4, and where the DL reference signal configuration indicates the number of measurement occasions (K) the WD 22 should use when computing the predicted beams at one or more future time instances (instead of configuring it in the CSI measurement configuration).

14. Embodiment 13 and where the DL reference signal configuration indicates at which time instances the K measurement occasions will occur.

15. Any of Embodiments 13 and 14, and where the configuration of the K time instances is configured per DL-RS resource set of the DL reference signal configuration (for example by configuring a repetition factor K per DL-RS resource set, which indicates that the transmission of the DL-RS resource set is repeated K times, and the WD 22 should use all the K transmission when computing the predicted beams at one or more future time instances).

16. 13, 14, and where the configuration of the K time instances is explicitly configured per DL-RS resource of the DL reference signal configuration (for example by configuring a repetition factor K per DL-RS resource, which indicates that the transmission of the DL-RS resource is repeated K times, and the WD 22 should use all the K transmission when computing the predicted beams at one or more future time instances).

17. Any of the above numerated Embodiments, and where a Measurement time occasion is defined as a time interval wherein the WD 22 receives all the beams in the set B of beams one time per beam.

18. Any of the above numerated Embodiments, and where Set A and Set B of beams are the same set of beams.

19. Any of the above numerated Embodiments, and where Set A and Set B of beams are different set of beams.

20. Any of the above numerated Embodiments, and where each DL-RS is associated with a TRS (for example by having the same spatial QCL), and where the WD 22 uses the associated TRS to compute different characteristics that may be used as input together with other measurements of a DL-RS (to compute a better channel state information prediction), where the characteristics may be one or more of:
a. Average delay;
b. Delay spread;
c. Doppler shift; and
d. Doppler spread.

Some embodiments may include one or more of the following:

Embodiment A1. A network node configured to communicate with a wireless device (WD), the network node configured to, and/or comprising a radio interface and/or comprising processing circuitry configured to:
configure the WD with a downlink reference signal configuration and a channel state information, CSI, measurement configuration; and
for each of K measurement times, transmit a downlink reference signal associated with a first set of beams for the measurement time, K being an integer greater than 0.

Embodiment A2. The network node of Embodiment A1, wherein the network node, radio interface and/or processing circuitry are further configured to receive at least one temporal beam prediction for a second set of beams.

Embodiment A3. The network node of Embodiment A2, wherein the first and second sets of beams at least partially overlap.

Embodiment A4. The network node of any of Embodiments A2 and A3, wherein the temporal beam prediction is based at least in part on received signal measurements.

Embodiment B1. A method implemented in a network node, the method comprising:
configuring the WD with a downlink reference signal configuration and a channel state information, CSI, measurement configuration; and
for each of K measurement times, transmitting a downlink reference signal associated with a first set of beams for the measurement time, K being an integer greater than 0.

Embodiment B2. The method of Embodiment B1, further comprising receiving at least one temporal beam prediction for a second set of beams.

Embodiment B3. The method of Embodiment B2, wherein the first and second sets of beams at least partially overlap.

Embodiment B4. The method of any of Embodiments B2 and B3, wherein the temporal beam prediction is based at least in part on received signal measurements.

Embodiment C1. A wireless device (WD) configured to communicate with a network node, the WD configured to, and/or comprising a radio interface and/or processing circuitry configured to:
receive a channel state information, CSI, measurement configuration and a downlink reference signal configuration;
perform at least one measurement based at least in part on the received downlink reference signal configuration and according to the CSI measurement configuration;
perform at least one temporal beam prediction based at least in part on the at least one measurement; and
transmit the at least one temporal beam prediction to the network node.

Embodiment C2. The WD of Embodiment C1, wherein the at least one temporal beam prediction is based at least in part on a received signal strength for a beam.

Embodiment C3. The WD of any of Embodiments C1 and C2, wherein the at least one temporal beam prediction includes predicting at least one beam from a first set of beams swept at K different measurement times.

Embodiment C4. The WD of any of Embodiments C1-C3, wherein the WD, radio interface and/or processing circuitry are further configured to report a beam prediction capability of the WD.

Embodiment D1. A method implemented in a wireless device (WD), the method comprising:
receiving a channel state information, CSI, measurement configuration and a downlink reference signal configuration;
performing at least one measurement based at least in part on the received downlink reference signal configuration and according to the CSI measurement configuration;
performing at least one temporal beam prediction based at least in part on the at least one measurement; and
transmitting the at least one temporal beam prediction to the network node.

Embodiment D2. The method of Embodiment D1, wherein the at least one temporal beam prediction is based at least in part on a received signal strength for a beam.

Embodiment D3. The method of any of Embodiments D1 and D2, wherein the at least one temporal beam prediction includes predicting at least one beam from a first set of beams swept at K different measurement times.

Embodiment D4. The method of any of Embodiments D1-D3, further comprising reporting a beam prediction capability of the WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3^{rd} Generation Partnership Project
5G Fifth Generation
ACK Acknowledgement
A1 Artificial Intelligence
AoA Angle of Arrival
CORESET Control Resource Set
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID identity
gNB gNodeB
MAC Medium Access Control
MAC-CE MAC Control Element
ML Machine Learning
NR New Radio
NW Network
OFDM Orthogonal Frequency Division Multiplexing
PBCH Physical Broadcast Channel
PCI Physical Cell Identity
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Strength Indicator
RSRQ Reference Signal Received Quality
RSSI Received Signal Strength Indicator
SCS Subcarrier Spacing
SINR Signal to Interference plus Noise Ratio
SSB Synchronization Signal Block
RL Reinforcement Learning
RS Reference Signal
Rx Receiver
TB Transport Block
TDD Time-Division Duplex
TCI Transmission configuration indication
TRP Transmission/Reception Point
Tx Transmitter
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to perform time domain predictions of network node beams from a set A of beams based on measurements of a set B of beams, the WD configured to:
receive from a network node a CSI report configuration configuring the WD to report at least one prediction of a beam from the Set A of beams based at least in part on a downlink reference signal configuration associated with the set B of beams; and
transmit to the network node a beam information report including at least one prediction of a beam from the Set A of beams for at least one future time instance of a first set of at least one future time instance in accordance with the CSI report configuration.

2. The WD of claim 1, wherein a first subset of the first set of future time instances is separated from a second subset of the first set of future time instances by a gap.

3.-10. (canceled)

11. A method in a wireless device, WD, configured to communicate with a network node and configured to perform time domain predictions of network node beams from a set A of beams based on measurements of a set B of beam, the method comprising:
receiving from the network node a CSI report configuration configuring the WD to report at least one prediction of a beam from the set A of beams based at least in part on a downlink reference signal configuration associated with the set B of beams; and
transmitting to the network node a beam information report including at least one prediction of a beam from the set A of beams for at least one future time instance of a first set of at least one future time instance in accordance with the CSI report configuration.

12. The method of claim 11, wherein the CSI report configuration further includes an indication of the at least one future time instance for the at least one beam prediction.

13. The method of claim 11, wherein the at least one future time instance includes a plurality of future time instances that are equally distributed in time.

14. The method of claim 11, wherein a first subset of the first set of future time instances is separated from a second subset of the first set of future time instances by a gap.

15. The method of claim 11, wherein the beam information report includes an instantaneous beam report.

16. The method of claim 11, wherein the CSI report configuration includes a beam prediction configuration indicating at least one beam for performing the at least one beam prediction.

17. The method of claim 16, wherein the beam prediction configuration indicates a prediction window for which beam predictions are determined.

18. The method of claim 17, wherein the beam prediction configuration indicates a plurality of prediction times for which beam predictions are determined.

19. The method of claim 16, wherein the beam prediction configuration indicates a first set of prediction times for a first set of beam predictions in a first window and a second set of prediction times for a second set of beam predictions in a second window.

20. The method of claim 10, further comprising transmitting a beam prediction capability including at least one of prediction window parameters, measurement window parameters and a delay between a measurement window and a prediction window.

21. A network node configured to configure a wireless device, WD, to perform time domain predictions of network node beams from a set A of beams based on measurements of a set B of beams, the network node configured to:
transmit to a WD a CSI report configuration configuring the WD to report at least one prediction of a beam from the set A of beams based at least in part on a downlink reference signal configuration associated with the set B of beams; and
receive from the WD a beam information report including at least one prediction of a beam from the set A of beams for at least one future time instance of a first set of at least one future time instance in accordance with the CSI report configuration.

22. The network node of claim 21, wherein the CSI report configuration includes a beam prediction configuration indicating at least one beam for performing the at least one beam prediction.

23.-30. (canceled)

31. A method in a network node configured to configure a wireless device, WD, to perform time domain predictions of network node beams from a set A of beams based on measurements of a set B of beams, the method comprising:
transmitting to a WD a CSI report configuration configuring the WD to report at least one prediction of a beam from the set A of beams based at least in part on a downlink reference signal configuration associated with the set B of beams; and
receiving from the WD a beam information report including at least one prediction of a beam from the set A of beams for at least one future time instance of a first set of at least one future time instance in accordance with the CSI report configuration.

32. The method of claim 21, wherein the CSI report configuration further includes an indication of the at least one future time instance for the at least one beam prediction.

33. The method of claim 21, wherein the at least one future time instance includes a plurality of future time instances that are equally distributed in time.

34. The method of claim 21, wherein a first subset of the first set of future time instances is separated from a second subset of the first set of future time instances by a gap.

35. The method of claim 21, wherein the beam information report includes an instantaneous beam report.

36. The method of claim 21, wherein the CSI report configuration includes a beam prediction configuration indicating at least one beam for performing the at least one beam prediction.

37.-40. (canceled)
